(19) United States
(12) Patent Application Publication
(10) Pub. No.: US 2025/0016837 A1
(43) Pub. Date: Jan. 9, 2025

(54) METHOD, USER EQUIPMENT, AND NETWORK NODE FOR FEATURE BASED PREAMBLE GROUPING

(71) Applicant: Telefonaktiebolaget LM Ericsson (publ), Stockholm (SE)

(72) Inventors: Jonas SEDIN, Brentford, Greater London (GB); Zhipeng LIN, NANJING Jiangsu (CN)

(73) Assignee: Telefonaktiebolaget LM Ericsson (publ), Stockholm (SE)

(21) Appl. No.: 18/570,682

(22) PCT Filed: Apr. 21, 2022
(86) PCT No.: PCT/CN2022/088143

§ 371 Date: Dec. 15, 2023

(30) Foreign Application Priority Data
Jun. 18, 2021 (WO) PCT/CN2021/100922
Jun. 25, 2021 (WO) PCT/CN2021/102258

(51) Int. Cl. H04W 74/0833; H04B 17/318

(52) U.S. Cl. CPC H04W 74/0833; H04B 17/328

(57) ABSTRACT

The present disclosure is related to a UE, a network node, and methods for feature based preamble grouping. A method at a UE for performing a random access procedure with a network node comprises: receiving a configuration for PRACH transmission; determining a first preamble from two or more groups of preambles indicated by the received configuration at least partially based on the received configuration and one or more measurements at the UE, the first preamble indicating whether one or more features are requested or not; and transmitting, to the network node, the PRACH transmission by using the first preamble.

### CROSS-REFERENCE TO RELATED APPLICATION(S)

This application claims priority to the PCT International Application No. PCT/CN2021/100922, entitled “METHOD, USER EQUIPMENT, AND NETWORK NODE FOR FEATURE BASED RANDOM ACCESS PROCEDURE”, filed on Jun. 18, 2021, and the PCT International Application No. PCT/CN2021/102258, entitled “METHOD, USER EQUIPMENT, AND NETWORK NODE FOR FEATURE BASED PREAMBLE GROUPING”, filed on Jun. 25, 2021, which are incorporated herein by reference in their entireties.

### TECHNICAL FIELD

The present disclosure is related to the field of telecommunication, and in particular, to a user equipment (UE), a network node, and methods for feature based preamble grouping.

### BACKGROUND

With the development of the electronic and telecommunications technologies, mobile devices, such as a mobile phone, a smart phone, a laptop, a tablet, a vehicle mounted device, becomes an important part of our daily lives. To support a numerous number of mobile devices, a highly efficient Radio Access Network (RAN), such as a fifth generation (5G) New Radio (NR) RAN, will be required.

In order to be able to carry the data across the 5G NR RAN, data and information is organized into a number of data channels. By organizing the data into various channels, a 5G communications system is able to manage the data transfers in an orderly fashion and the system is able to understand what data is arriving and hence it is able to process the data in the required fashion. As there are many different types of data that need to be transferred-user data obviously needs to be transferred, but so does control information to manage the radio communications link, as well as data to provide synchronization, access, and the like. All of these functions are essential and require the transfer of data over the RAN.

In order to group the data to be sent over the 5G NR RAN, the data is organized in a very logical way. As there are many different functions for the data being sent over the radio communications link, they need to be clearly marked and have defined positions and formats. To ensure this happens, there are several different forms of data “channel” that are used. The higher level ones are “mapped” or contained within others until finally at the physical level, the channel contains data from higher level channels.

In this way there is a logical and manageable flow of data from the higher levels of the protocol stack down to the physical layer.

There are three main types of data channels that are used for a 5G RAN, and accordingly the hierarchy is given below.
Logical channel: Logical channels can be one of two groups: control channels and traffic channels:
   Control channels: The control channels are used for the transfer of data from the control plane; and
   Traffic channels: The traffic logical channels are used for the transfer of user plane data.
Transport channel: Is the multiplexing of the logical data to be transported by the physical layer and its channels over the radio interface.
Physical channel: The physical channels are those which are closest to the actual transmission of the data over the radio access network/5G Radio Frequency (RF) signal. They are used to carry the data over the radio interface.

The physical channels often have higher level channels mapped onto them for providing a specific service. Additionally, the physical channels carry payload data or details of specific data transmission characteristics like modulation, reference signal multiplexing, transmit power, RF resources, etc.

The 5G physical channels are used to transport information over the actual radio interface. They have the transport channels mapped into them, but they also include various physical layer data required for the maintenance and optimization of the radio communications link between a UE and a base station (BS).

There are three physical channels for each of the uplink and downlink: Physical Downlink Shared Channel (PDSCH), Physical Downlink Control Channel (PDCCH), and Physical Broadcast Channel (PBCH) for downlink, and Physical Random Access Channel (PRACH), Physical Uplink Shared Channel (PUSCH), and Physical Uplink Control Channel (PUCCH) for uplink.

### SUMMARY

According to a first aspect of the present disclosure, a method at a UE for performing a random access procedure with a network node is provided. The method comprises: receiving a configuration for PRACH transmission; determining a first preamble from two or more groups of preambles indicated by the received configuration at least partially based on the received configuration and one or more measurements at the UE, the first preamble indicating whether one or more features are requested or not; and transmitting, to the network node, the PRACH transmission by using the first preamble.

In some embodiments, the first preamble further indicates that whether a transport block size (TBS) for Msg3 that is greater than a TBS threshold indicated by the received configuration is requested or not. In some embodiments, the one or more features comprise at least one of: —Msg3 repetition; —MsgA repetition; —a network slice; —small data transmission (SDT); —a UE with reduced capability (RedCap UE); —a random access in non-terrestrial network; and—a specific service type or UE priority.

In some embodiments, the two or more groups comprise at least a first group and a second group, each preamble in the first group indicating that a first feature of the one or more features is not requested and each preamble in the second group indicating that the first feature is requested. In some embodiments, each preamble in the first group further indicates that a TBS for Msg3 that is greater than a TBS threshold indicated by the received configuration is not requested, wherein the two or more groups further comprises a third group, each preamble in the third group indicating: —a TBS for Msg3 that is greater than the TBS threshold is requested; and—the first feature is not requested.

In some embodiments, the two or more groups comprise no group indicating both of: —a TBS for Msg3 that is greater than the TBS threshold is requested; and—the first feature is requested. In some embodiments, the step of determining a first preamble comprises: determining whether the first feature is to be requested or not; selecting a preamble from the second group as the first preamble in response to determining that the first feature is to be requested. In some embodiments, the step of determining a first preamble comprises: determining whether the first feature is to be requested or not; determining whether a TBS for Msg3 that is greater than the TBS threshold is to be requested or not; selecting a preamble from the first group as the first preamble in response to determining that the first feature is not to be requested and that the greater TBS is not to be requested. In some embodiments, the step of determining a first preamble comprises: determining whether the first feature is to be requested or not; determining whether a TBS for Msg3 that is greater than the TBS threshold is to be requested or not; selecting a preamble from the third group as the first preamble in response to determining that the first feature is not to be requested and that the greater TBS is to be requested.

In some embodiments, the two or more groups further comprise a fourth group indicating both of: —a TBS for Msg3 that is greater than the TBS threshold is requested; and—the first feature is requested. In some embodiments, the received configuration comprises a same set of parameters shared by both of the third group and the fourth group. In some embodiments, the same set of parameters indicate explicitly or implicitly at least one of: —a common TBS threshold below which no preamble shall be selected from the third or fourth group; —a common power threshold below which no preamble shall be selected from the third or fourth group; and—a common number that indicates how many preambles are there in the third or fourth group. In some embodiments, when the same set of parameters comprise no common power threshold, the received configuration further comprises a parameter indicating a power offset that is used together with the power threshold configured for the third group to determine the power threshold for the fourth group. In some embodiments, the received configuration comprises separate sets of parameters for the third group and the fourth group, respectively. In some embodiments, each of the separate sets of parameters indicates explicitly or implicitly at least one of: —a group specific TBS threshold below which no preamble shall be selected from a corresponding group; —a group specific power threshold below which no preamble shall be selected from a corresponding group; —a group specific number that indicates how many preambles are there in a corresponding group.

In some embodiments, the step of determining a first preamble comprises: determining one of multiple pathloss ranges to which a first pathloss, which is determined at least partially based on Reference Signal Received Power (RSRP) of a downlink pathloss reference measured at the UE, belongs; and selecting a preamble from one of the first, second, third, and fourth group as the first preamble at least partially based on the determined pathloss range. In some embodiments, the multiple pathloss ranges comprise: —a first pathloss range, any value of which being greater than or equal to a first pathloss threshold, wherein no preamble shall be selected from the fourth group when the first pathloss is greater than or equal to the first pathloss threshold; —a second pathloss range, any value of which being less than the first pathloss threshold and greater than a second pathloss threshold corresponding to a power threshold that is configured for determining whether the first feature is to be requested or not; —a third pathloss range, any value of which being less than or equal to the second pathloss threshold and greater than or equal to a third pathloss threshold, wherein no preamble shall be selected from the third group when the first pathloss is greater than or equal to the third pathloss threshold; and—a fourth pathloss range, any value of which being less than the third pathloss threshold.

In some embodiments, the step of selecting a preamble from one of the first, second, third, and fourth group as the first preamble at least partially based on the determined pathloss range comprises at least one of: selecting a preamble from the second group as the first preamble at least partially in response to determining that the first pathloss belongs to the first pathloss range and determining that a TBS for Msg3 that is greater than the TBS threshold is not to be requested; selecting a preamble from the fourth group as the first preamble at least partially in response to determining that the first pathloss belongs to the second pathloss range and determining that a TBS for Msg3 that is greater than the TBS threshold is to be requested; selecting a preamble from the first group as the first preamble at least partially in response to determining that the first pathloss belongs to the third pathloss range and determining that a TBS for Msg3 that is greater than the TBS threshold is not to be requested; and selecting a preamble from the third group as the first preamble at least partially in response to determining that the first pathloss belongs to the fourth pathloss range and determining that a TBS for Msg3 that is greater than the TBS threshold is to be requested.

In some embodiments, whether the two or more groups comprise a fourth group or not is at least partially based on whether RACH occasions (RO) are shared by a first RA procedure to which the PRACH transmission belongs and a second RA procedure that is different from the first RA procedure or not, wherein the fourth group indicates both of: —a TBS for Msg3 that is greater than the TBS threshold is requested; and—the first feature is requested. In some embodiments, the second RA procedure is different from the first RA procedure in at least one of: —whether at least one of the one or more features is requested or not; —whether a feature other than the one or more features is requested or not; and—whether it is a Type-1 RA procedure or a Type-2 RA procedure.

In some embodiments, when the received configuration indicates RO are shared by the first and second RA procedures, the two or more groups comprise no group that indicates both of: —a TBS for Msg3 that is greater than the TBS threshold is requested; and—the first feature is requested. In some embodiments, when the received configuration indicates RO are not shared by the first and second RA procedures, the two or more groups further comprise a fourth group that indicates both of: —a TBS for Msg3 that is greater than the TBS threshold is requested; and—the first feature is requested.

In some embodiments, the two or more groups comprise at least a first group and multiple second groups, each preamble in the first group indicating that a first feature of the one or more features is not requested and each preamble in each second group indicating that the first feature is requested, wherein each preamble in each second group indicates that a TBS for Msg3 that belongs to a TBS range configured for the corresponding second group is requested. In some embodiments, when the first feature is Msg3 repetition, each of the two or more groups indicating that Msg3 repetition is requested is associated with a group specific maximum number of Msg3 repetitions requested. In some embodiments, the group specific maximum number of Msg3 repetitions requested is signaled by the network node.

In some embodiments, the received configuration comprises one or more criteria for dividing all the preambles, which are available for grouping, into the two or more groups, and the one or more criteria comprise at least one of: —whether a preamble is used for contention based random access (CBRA) or contention free random access (CFRA); —whether a preamble is used for Type-1 RA procedure or Type-2 RA procedure; —whether RACH occasions are shared or separately configured for Type-1 and Type-2 RACH procedures; —whether a TBS for Msg3 that belongs to a specific TBS range is requested or not; —a power threshold for determining whether the UE is allowed to use preambles in a corresponding group based on its measured RSRP of the DL pathloss reference; —whether a specific maximum number of Msg3 repetitions is requested or not; —whether Msg3 repetition is requested or not; —whether MsgA repetition is requested or not; —whether a network slice is requested or not; —whether SDT is requested or not; —whether to indicate the UE as a RedCap UE or not; —whether to indicate a random access in non-terrestrial network or not; and—whether to indicate a specific service type or UE priority.

In some embodiments, the method further comprises: in response to an RA switching for changing at least one of the one or more criteria, determining a second preamble from the two or more groups at least partially based on the first preamble determined before the RA switching. In some embodiments, a first part of a request indicated by the second preamble is different from a corresponding first part of a request indicated by the first preamble, each of the first parts being related to the at least one criterion, and a second part of the request indicated by the second preamble is same as a corresponding second part of the request indicated by the first preamble, each of the second parts being related to other criteria than the at least one criterion.

In some embodiments, the two or more groups are sequentially ordered in its preamble space as follows: —a group for CBRA of Type-1 RA indicating a TBS that is less than or equal to a TBS threshold and indicating the first feature is not requested, if present; —a group for CBRA of Type-1 RA indicating a TBS that is greater than a TBS threshold and indicating the first feature is not requested, if present; —a group for CBRA of Type-1 RA indicating a TBS that is less than or equal to a TBS threshold and indicating the first feature is requested, if present; —a group for CBRA of Type-1 RA indicating a TBS that is greater than a TBS threshold and indicating the first feature is requested, if present; —a group for CBRA of Type-2 RA indicating a TBS that is less than or equal to a TBS threshold and indicating the first feature is not requested, if present; —a group for CBRA of Type-2 RA indicating a TBS that is greater than a TBS threshold and indicating the first feature is not requested, if present; and—a group for CFRA of Type-1 RA indicating a TBS that is less than or equal to a TBS threshold, if present.

In some embodiments, the two or more groups are sequentially ordered in its preamble space as follows: —a group for CBRA of Type-1 RA indicating a TBS that is less than or equal to a TBS threshold and indicating the first feature is not requested, if present; —a group for CBRA of Type-1 RA indicating a TBS that is greater than a TBS threshold and indicating the first feature is not requested, if present; —a group for CBRA of Type-2 RA indicating a TBS that is less than or equal to a TBS threshold and indicating the first feature is not requested, if present; —a group for CBRA of Type-2 RA indicating a TBS that is greater than a TBS threshold and indicating the first feature is not requested, if present; —a group for CBRA of Type-1 RA indicating a TBS that is less than or equal to a TBS threshold and indicating the first feature is requested, if present; —a group for CBRA of Type-1 RA indicating a TBS that is greater than a TBS threshold and indicating the first feature is requested, if present; and—a group for CFRA of Type-1 RA indicating a TBS that is less than or equal to a TBS threshold, if present.

In some embodiments, one or more groups for indicating that the first feature is requested is generated from a same root value as that for one or more groups for CBRA of Type-1 RA and/or one or more groups for CBRA of Type-2 RA.

In some embodiments, the two or more groups are sequentially ordered in its preamble space by their numbers of preambles in a predetermined order or an order signaled from the network node. In some embodiments, the order is an increasing order. In some embodiments, when the PRACH transmission is not a part of a Type-2 RA procedure, the method further comprises: receiving, from the network node, a random access response (RAR) comprising an indicator indicating whether the first feature is to be used or not; and transmitting, to the network node, a Msg3 with or without the first feature depending on the received indicator.

According to a second aspect of the present disclosure, a UE is provided. The UE comprises: a processor; a memory storing instructions which, when executed by the processor, cause the processor to perform the method of any of the first aspect.

According to a third aspect of the present disclosure, a method at a network node for performing a random access procedure with a UE is provided. The method comprises: broadcasting or transmitting, to the UE, a configuration for PRACH transmission; receiving the PRACH transmission comprising a first preamble that is selected by the UE from two or more groups of preambles indicated by the configuration, the first preamble itself indicating whether one or more features are requested by the UE or not; and transmitting, to the UE, a RAR at least partially based on whether the one or more features are requested by the UE or not.

In some embodiments, the first preamble further indicates that whether a TBS for Msg3 that is greater than a TBS threshold indicated by the received configuration is requested or not. In some embodiments, the one or more features comprise at least one of: —Msg3 repetition; —MsgA repetition; —a network slice; —SDT; —a RedCap UE; —a random access in non-terrestrial network; and—a specific service type or UE priority. In some embodiments, the two or more groups comprise at least a first group and a second group, each preamble in the first group indicating that a first feature of the one or more features is not requested and each preamble in the second group indicating that the first feature is requested. In some embodiments, each preamble in the first group further indicates that a TBS for Msg3 that is greater than a TBS threshold indicated by the received configuration is not requested, wherein the two or more groups further comprises a third group, each preamble in the third group indicating: —a TBS for Msg3 that is greater than the TBS threshold is requested; and—the first feature is not requested.

In some embodiments, the two or more groups comprise no group indicating both of: —a TBS for Msg3 that is greater than the TBS threshold is requested; and—the first feature is requested. In some embodiments, the two or more groups further comprise a fourth group indicating both of: —a TBS for Msg3 that is greater than the TBS threshold is requested; and—the first feature is requested. In some embodiments, the configuration comprises a same set of parameters shared by both of the third group and the fourth group. In some embodiments, the same set of parameters indicate explicitly or implicitly at least one of: —a common TBS threshold below which no preamble shall be selected by the UE from the third or fourth group; —a common power threshold below which no preamble shall be selected by the UE from the third or fourth group; and—a common number that indicates how many preambles are there in the third or fourth group. In some embodiments, when the same set of parameters comprise no common power threshold, the received configuration further comprises a parameter indicating a power offset that is used together with the power threshold configured for the third group to determine the power threshold for the fourth group.

In some embodiments, the received configuration comprises separate sets of parameters for the third group and the fourth group, respectively. In some embodiments, each of the separate sets of parameters indicates explicitly or implicitly at least one of: —a group specific TBS threshold below which no preamble shall be selected from a corresponding group; —a group specific power threshold below which no preamble shall be selected from a corresponding group; —a group specific number that indicates how many preambles are there in a corresponding group. In some embodiments, the first preamble belongs to a group of the two or more groups corresponding to one of multiple pathloss ranges to which a first pathloss belongs, wherein the first pathloss is determined by the UE at least partially based on RSRP of a downlink pathloss reference measured at the UE.

In some embodiments, the multiple pathloss ranges comprise: —a first pathloss range, any value of which being greater than or equal to a first pathloss threshold, wherein no preamble shall be selected from the fourth group when the first pathloss is greater than or equal to the first pathloss threshold; —a second pathloss range, any value of which being less than the first pathloss threshold and greater than a second pathloss threshold corresponding to a power threshold that is configured for determining whether the first feature is to be requested or not; —a third pathloss range, any value of which being less than or equal to the second pathloss threshold and greater than or equal to a third pathloss threshold, wherein no preamble shall be selected from the third group when the first pathloss is greater than or equal to the third pathloss threshold; and—a fourth pathloss range, any value of which being less than the third pathloss threshold.

In some embodiments, whether the two or more groups comprise a fourth group or not is at least partially based on whether RO are shared by a first RA procedure to which the PRACH transmission belongs and a second RA procedure that is different from the first RA procedure or not, wherein the fourth group indicates both of: —a TBS for Msg3 that is greater than the TBS threshold is requested; and—the first feature is requested. In some embodiments, the second RA procedure is different from the first RA procedure in at least one of: —whether at least one of the one or more features is requested or not; —whether a feature other than the one or more features is requested or not; and—whether it is a Type-1 RA procedure or a Type-2 RA procedure.

In some embodiments, when the configuration indicates RO are shared by the first and second RA procedures, the two or more groups further comprise no group that indicates both of: —a TBS for Msg3 that is greater than the TBS threshold is requested; and—the first feature is requested.

In some embodiments, when the configuration indicates RO are not shared by the first and second RA procedures, the two or more groups further comprise a fourth group that indicates both of: —a TBS for Msg3 that is greater than the TBS threshold is requested; and—the first feature is requested. In some embodiments, the two or more groups comprise at least a first group and multiple second groups, each preamble in the first group indicating that a first feature of the one or more features is not requested and each preamble in each second group indicating that the first feature is requested, wherein each preamble in each second group indicates that a TBS for Msg3 that belongs to a TBS range configured for the corresponding second group is requested. In some embodiments, when the first feature is Msg3 repetition, each of the two or more groups indicating that Msg3 repetition is requested is associated with a group specific maximum number of Msg3 repetitions. In some embodiments, the group specific maximum number of Msg3 repetitions is signaled to the UE.

In some embodiments, the configuration comprises one or more criteria for dividing all the preambles, which are available for grouping, into the two or more groups, and the one or more criteria comprise at least one of: —whether a preamble is used for CBRA or CFRA; —whether a preamble is used for Type-1 RA procedure or Type-2 RA procedure; —whether RACH occasions are shared or separately configured for Type-1 and Type-2 RACH procedures; —whether a TBS for Msg3 that belongs to a specific TBS range is requested or not; —a power threshold for determining whether the UE is allowed to use preambles in a corresponding group based on its measured RSRP of the DL pathloss reference; —whether a specific maximum number of Msg3 repetitions is requested or not; —whether Msg3 repetition is requested or not; —whether MsgA repetition is requested or not; —whether a network slice is requested or not; —whether SDT is requested or not; —whether to indicate the UE as a RedCap UE or not; —whether to indicate a random access in non-terrestrial network or not; and—whether to indicate a specific service type or UE priority.

In some embodiments, the two or more groups are sequentially ordered in its preamble space as follows: —a group for CBRA of Type-1 RA indicating a TBS that is less than or equal to a TBS threshold and indicating the first feature is not requested, if present; —a group for CBRA of Type-1 RA indicating a TBS that is greater than a TBS threshold and indicating the first feature is not requested, if present; —a group for CBRA of Type-1 RA indicating a TBS that is less than or equal to a TBS threshold and indicating the first feature is requested, if present; —a group for CBRA of Type-1 RA indicating a TBS that is greater than a TBS threshold and indicating the first feature is requested, if present; —a group for CBRA of Type-2 RA indicating a TBS that is less than or equal to a TBS threshold and indicating the first feature is not requested, if present; —a group for CBRA of Type-2 RA indicating a TBS that is greater than a TBS threshold and indicating the first feature is not requested, if present; and—a group for CFRA of Type-1 RA indicating a TBS that is less than or equal to a TBS threshold, if present.

In some embodiments, the two or more groups are sequentially ordered in its preamble space as follows: —a group for CBRA of Type-1 RA indicating a TBS that is less than or equal to a TBS threshold and indicating the first feature is not requested, if present; —a group for CBRA of Type-1 RA indicating a TBS that is greater than a TBS threshold and indicating the first feature is not requested, if present; —a group for CBRA of Type-2 RA indicating a TBS that is less than or equal to a TBS threshold and indicating the first feature is not requested, if present; —a group for CBRA of Type-2 RA indicating a TBS that is greater than a TBS threshold and indicating the first feature is not requested, if present; —a group for CBRA of Type-1 RA indicating a TBS that is less than or equal to a TBS threshold and indicating the first feature is requested, if present; —a group for CBRA of Type-1 RA indicating a TBS that is greater than a TBS threshold and indicating the first feature is requested, if present; and—a group for CFRA of Type-1 RA indicating a TBS that is less than or equal to a TBS threshold, if present.

In some embodiments, one or more groups for indicating that the first feature is requested is generated from a same root value as that for one or more groups for CBRA of Type-1 RA and/or one or more groups for CBRA of Type-2 RA. In some embodiments, the two or more groups are sequentially ordered in its preamble space by their numbers of preambles in a predetermined order or an order signaled from the network node. In some embodiments, the order is an increasing order.

In some embodiments, when the PRACH transmission is not a part of a Type-2 RA procedure, the method further comprises: receiving, from the UE, a Msg3 with the feature enabled or disabled depending on the RAR.

According to a fourth aspect of the present disclosure, a network node is provided. The network node comprises: a processor; a memory storing instructions which, when executed by the processor, cause the processor to perform the method of any of the third aspect.

According to a fifth aspect of the present disclosure, a computer program comprising instructions is provided. The instructions, when executed by at least one processor, cause the at least one processor to carry out the method of any of the first or third aspect.

According to a sixth aspect of the present disclosure, a carrier containing the computer program of the fifth aspect is provided. The carrier is one of an electronic signal, optical signal, radio signal, or computer readable storage medium.

According to a seventh aspect of the present disclosure, a telecommunications system is provided. The telecommunications system comprises one or more UEs of the second aspect; and at least one network node of the fourth aspect.

### BRIEF DESCRIPTION OF THE DRAWINGS

FIG. 1 shows flow charts illustrating exemplary Type-1 and Type-2 RA procedures, respectively, with which a UE and gNB according to an embodiment of the present disclosure may be operable.

FIG. 2 is a diagram illustrating an exemplary one-to-one mapping between SSBs and PRACH occasions with which a UE and gNB according to an embodiment of the present disclosure may be operable.

FIG. 3 is a diagram illustrating an exemplary many-to-one mapping between SSBs and PRACH occasions with which a UE and gNB according to an embodiment of the present disclosure may be operable.

FIG. 4 is a diagram illustrating an exemplary preamble grouping in the related art.

FIG. 5 is a diagram illustrating an exemplary preamble grouping according to an embodiment of the present disclosure.

FIG. 6 is a diagram illustrating an exemplary preamble grouping according to an embodiment of the present disclosure.

FIG. 7 is a diagram illustrating exemplary criteria for grouping preambles according to an embodiment of the present disclosure.

FIG. 8 is a diagram illustrating an exemplary preamble grouping according to an embodiment of the present disclosure.

FIG. 9 is a diagram illustrating an exemplary preamble grouping according to an embodiment of the present disclosure.

FIG. 10 is a flow chart illustrating an exemplary method at a UE for feature based preamble grouping according to an embodiment of the present disclosure.

FIG. 11 is a flow chart illustrating an exemplary method at a network node for feature based preamble grouping according to an embodiment of the present disclosure.

FIG. 12 schematically shows an embodiment of an arrangement which may be used in a UE or a network node according to an embodiment of the present disclosure.

FIG. 13 is a block diagram of an exemplary UE according to an embodiment of the present disclosure.

FIG. 14 is a block diagram of an exemplary network node according to an embodiment of the present disclosure.

FIG. 15 schematically illustrates a telecommunication network connected via an intermediate network to a host computer according to an embodiment of the present disclosure.

FIG. 16 is a generalized block diagram of a host computer communicating via a base station with a user equipment over a partially wireless connection according to an embodiment of the present disclosure.

FIG. 17 to FIG. 20 are flowcharts illustrating methods implemented in a communication system including a host computer, a base station, and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as a random access procedure is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division—Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “gNB” used herein may refer to a network node, a base station, a base transceiver station, an access point, a hot spot, a NodeB, an Evolved NodeB, a network element, or any other equivalents. Further, please note that the term “indicator” used herein may refer to a parameter, a coefficient, an attribute, a property, a setting, a configuration, a profile, an identifier, a field, one or more bits/octets, an information element, or any data by which information of interest may be indicated directly or indirectly.

Further, following 3GPP documents are incorporated herein by reference in their entireties:
3GPP TS 38.321 V16.4.0 (2021 March), 3rd Generation Partnership Project;
Technical Specification Group Radio Access Network; NR; Medium Access Control (MAC) protocol specification (Release 16); and
3GPP TS 38.331 V16.4.1 (2021 March), 3rd Generation Partnership Project; Technical Specification Group Radio Access Network; NR; Radio Resource Control (RRC) protocol specification (Release 16).

When a UE wants to access to a 5G NR network, it has to synchronize in downlink as well as in uplink. Downlink synchronization may be obtained after successfully decoding Synchronous Signal and PBCH block (SSB). In order to establish uplink synchronization and an RRC connection, the UE has to perform a random access procedure.

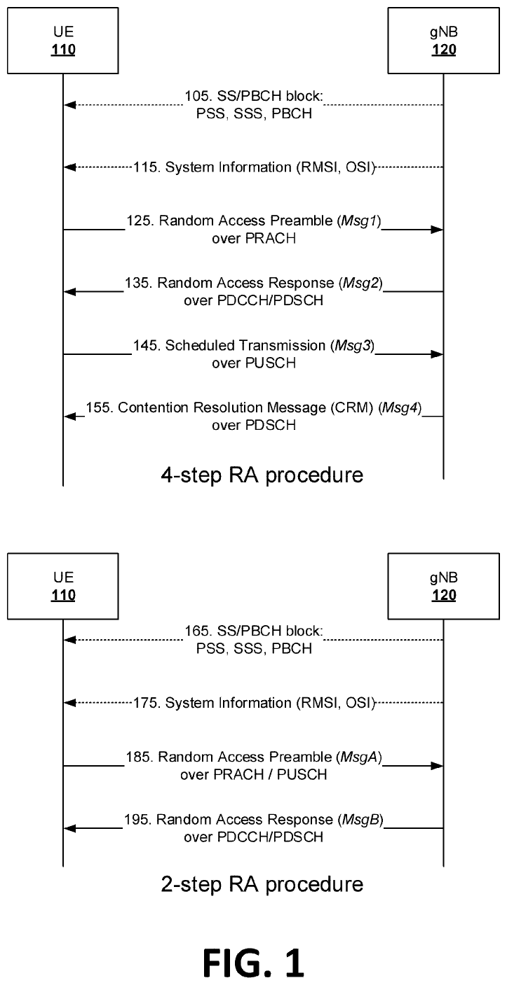

FIG. 1 shows flow charts illustrating exemplary Type-1 and Type-2 RA procedures, respectively, with which a UE and gNB according to an embodiment of the present disclosure may be operable. As shown in FIG. 1, there are two types of RA procedures:
Type-1 RA procedure, also known as 4-step RACH, or 4-step RA procedure; and
Type-2 RA procedure, also known as 2-step RACH, or 2-step RA procedure.

Further, RA procedures may also be classified into Contention Based Random Access (CBRA) or Non Contention or Contention Free Random Access (CFRA) depending on how its resource is selected. In the contention based RA procedure, a UE may select a preamble randomly from a pool of preambles shared with other UEs. This means that the UE has a potential risk of selecting a same preamble as another UE and subsequently may experience conflict or contention. The gNB may use a contention resolution mechanism to handle this type of access requests. In this procedure, the result is random and not all RA succeeds.

Referring to the top flow chart of FIG. 1, an exemplary 4-step RA procedure may comprise four steps 125 to 155 for a UE 110 to access a gNB 120 after necessary system information, which is broadcasted by the gNB 120, is obtained at the steps 105 and 115.

At step 105, the UE 110 may receive a Master Information Block (MIB) from the gNB 120 by detecting an SSB which may comprise a Primary Synchronous Signal (PSS), a Secondary Synchronous Signal (SSS), and a PBCH carrying the MIB. Upon successful reception and decoding of the MIB, the UE 110 may determine time/frequency positions for monitoring Remaining Minimum System Information (RMSI) or System Information Block 1 (SIB1) broadcasted by the gNB 120, for example, by a pdcch-ConfigSIB1 information element (IE) comprised in the MIB.

At step 115, the UE 110 may receive the RMSI and Other System Information (OSI) from the gNB 120. For example, the UE 110 may receive and decode the RMSI (SIB1) based on the information determined at the step 105 to determine time/frequency positions for monitoring OSI broadcasted by the gNB 120, for example, by a searchSpaceOtherSystemInformation IE comprised in the SIB1. Further, the UE 110 may also obtain any parameters necessary for the 4-step RA procedure. For example, the UE 110 may determine a set of preambles by a RACH-ConfigCommon IE which can be used later during the 4-step RA procedure.

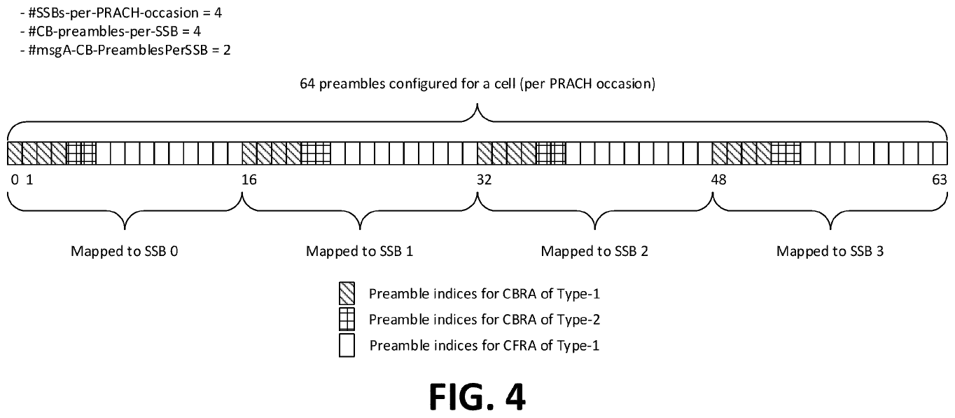

At step 125, the UE 110 may transmit a preamble which is selected from the set of preambles determined at the step 115 to the gNB 120 in Msg1. The selection of the preamble may be performed in a manner described with reference to FIG. 4 to FIG. 9 or in any other manner, for example, in a random manner.

At step 135, upon reception of Msg1, the gNB 120 may select a Temporary Cell-Radio Network Temporary Identifier (TC-RNTI) and uplink and downlink scheduling resources for the UE 110. Then, the gNB 120 may transmit an RA response (RAR or Msg2) over PDCCH/PDSCH. The response may contain the RA-preamble identifier, timing alignment information, initial uplink grant, and the TC-RNTI. One PDSCH may carry RA responses to multiple UEs. On the other hand, after transmitting the preamble, the UE 110 may monitor the PDCCH and wait for the RAR within an RA response window:
If the UE 110 receives a response containing an RA-preamble identifier which is the same as the identifier contained in the transmitted RA preamble, the response is successful. The UE 110 may then transmit uplink scheduling information later.
If the UE 110 does not receive a response within the RA response window or fails to verify the response, the response fails. In this case, if the number of RA attempts is less than the upper limit (e.g., 10), the UE 110 may retry the RA procedure. Otherwise, the RA procedure fails.

Further, the UE 110 may use the timing alignment information comprised in the RAR to adjust the timing of any subsequent PUSCH transmission, allowing PUSCH to be received at the gNB 120 with a timing accuracy within the cyclic prefix (CP). Without this timing advance functionality, a very large CP would be needed in order to be able to demodulate and detect PUSCH, unless the system is applied in a cell with very short distance between the UE 110 and the gNB 120. Since NR will also support larger cells, there is a need for providing a timing advance to the UE 110.

At step 145, the UE 110 may transmit uplink scheduling information (Msg3) over the PUSCH. The signaling messages and information transmitted by the UE 110 may vary across different RA scenarios and some examples are listed below:
Initial RRC connection setup: The RRCSetupRequest message (carrying NAS UE_ID) is transmitted over the common control channel (CCCH) in TM at the Radio Link Control (RLC) layer. The message is not segmented.
RRC connection reestablishment: The RRC Reestablishment Request message (not carrying the NAS message) is transmitted over the CCCH in TM at the RLC layer. The message is not segmented.
Handover: Contention-based RA, instead of contention-free RA, is triggered if the UE 110 accesses the target cell and no dedicated preambles are available during a handover. The RRC Handover Confirm message and C-RNTI are transmitted over the dedicated control channel (DCCH). If required, a buffer status report (BSR) may also be carried.
Other scenarios: At least the C-RNTI of the UE 110 may be transmitted.

At step 155, after transmitting the Msg3, a contention resolution timer may be started at the UE 110. The gNB 120 may assist the UE 110 in contention resolution using the C-RNTI on the PDCCH or using the UE Contention Resolution Identity IE on the PDSCH.

The UE 110 may keep monitoring the PDCCH before the timer expires and considers the contention resolution successful and stops the timer if either of the following conditions is met:
The UE 110 receives a PDCCH on its C-RNTI.
The UE 110 successfully decodes the MAC PDU addressed by the temporary C-RNTI. Specifically, the UE Contention Resolution Identity IE received over the PDSCH is the same as that carried in Msg3 sent by the UE.

If the contention resolution timer expires, the UE 110 may consider the contention resolution failed. Then, the UE 110 may perform the RA procedure again if the number of RA attempts has not reached the upper limit. If the number of RA attempts has reached its upper limit, the RA procedure fails.

In non-contention based Random Access or CFRA, the preamble may be pre-allocated by the gNB 120 and such preambles may be known as dedicated random access preamble. The dedicated preamble may be provided to the UE 110 either via RRC signalling (e.g., allocated preamble(s) can be specified within an RRC message) or PHY Layer signalling (e.g., DCI on the PDCCH). Therefore, there is no preamble conflict. When dedicated resources are insufficient, the gNB 120 may instruct UEs to initiate contention-based RA.

The gNB 120 may allocate an RA preamble to the UE 110 and sent it using an RRC message or DCI signaling. Some scenarios are listed below:
Handover: The MobilityControlInfo IE sent by the source gNB may carry the allocated preamble;
DL Data Arrival: When downlink data arrives at the gNB 120, the gNB 120 may instruct the UE 110 to initiate an RA procedure through DCI over PDCCH, which carries the allocated preamble;
Non-Standalone (NSA) networking: When NR cells are added in NSA, the gNB 120 may instruct the UE 110 to initiate an RA procedure through the PDCCH, which carries the allocated preamble.

Referring to the bottom flow chart of FIG. 1, an exemplary 2-step RA procedure may comprise two steps 185 and 195 for a UE 110 to access a gNB 120 after necessary system information, which is broadcasted by the gNB 120, is obtained at the steps 165 and 175.

Similar to the step 105, at step 165, the UE 110 may receive a MIB from the gNB 120 by detecting an SSB. Upon successful reception and decoding of the MIB, the UE 110 may determine time/frequency positions for monitoring RMSI or SIB1 broadcasted by the gNB 120.

Similar to the step 115, at step 175, the UE 110 may receive the RMSI and OSI from the gNB 120. For example, the UE 110 may receive and decode the RMSI (SIB1) based on the information determined at the step 105 to determine time/frequency positions for monitoring OSI broadcasted by the gNB 120, for example, by a searchSpaceOtherSystemInformation IE comprised in the SIB1. Further, the UE 110 may also obtain any parameters necessary for the 2-step RA procedure. For example, the UE 110 may determine available time/frequency occasions for PRACH by a msgA-ConfigCommon IE comprised in the SIB1, which can be used later during the 2-step RA procedure.

Similar to the step 125, at the step 185, the UE 110 may transmit to the gNB 120 an RA preamble (MsgA), which may be pre-allocated by the gNB 120 when it is a CFRA procedure, together with higher layer data such as an RRC connection request possibly with some small additional payload on PUSCH. In such a case, no confliction with other UEs will happen.

Similar to the step 135, the gNB 120 may transmit an RA response (MsgB) to the UE 110. Since no conflict with other UEs will occur, and the steps for contention resolving (e.g., Msg3 and Msg4 in the 4-step RA procedure) may be omitted.

In the handover scenario, the RA response may contain the timing alignment information and initial uplink grant. In the DL data arrival scenario, when downlink data arrives at the gNB 120, the RA response may contain the timing alignment information and RA preamble identifier (RAPID). In the NSA networking scenario, when NR cells are added in NSA, the RA response may contain the timing alignment information and RAPID.

Please note that although FIG. 1 shows a 4-step contention-based RA procedure (or CBRA of Type 1) and a 2-step non-contention-based RA procedure (or CFRA of Type 2), the present disclosure is not limited thereto. In other embodiments, other RA procedures may also be applicable, such as, a 4-step non-contention-based RA procedure (or CFRA of Type 1) and/or a 2-step contention-based RA procedure (or CBRA of Type 2).

In 3GPP RAN #90e, the following objectives have been approved for NR coverage enhancement work item in NR Rel-17 for PUSCH:
Specification of PUSCH enhancements [RAN1, RAN4]
   Specify the following mechanisms for enhancements on PUSCH repetition type A [RAN1]
      Increasing the maximum number of repetitions up to a number to be determined during the course of the work.
      The number of repetitions counted on the basis of available UL slots.
   Specify mechanism(s) to support transport block (TB) processing over multi-slot PUSCH [RAN1]
      TB size (TBS) determined based on multiple slots and transmitted over multiple slots.
   Specify mechanism(s) to enable joint channel estimation [RAN1, RAN4]
      Mechanism(s) to enable joint channel estimation over multiple PUSCH transmissions, based on the conditions to keep power consistency and phase continuity to be investigated and specified if necessary by RAN4 [RAN1, RAN4]
         Potential optimization of DMRS location/granularity in time domain is not precluded
      Inter-slot frequency hopping with inter-slot bundling to enable joint channel estimation [RAN1]
Specification of PUCCH enhancements [RAN1, RAN4]
   Specify signaling mechanism to support dynamic PUCCH repetition factor indication [RAN1]
   Specify mechanism to support DMRS bundling across PUCCH repetitions [RAN1, RAN4]
Specify mechanism(s) to support Type A PUSCH repetitions for Msg3 [RAN1]

In some embodiments of the present disclosure, the Type A PUSCH repetitions for Msg3 will be described.

As already described with reference to FIG. 1, two types of random access procedures are supported in NR till release 16, where a MsgA PUSCH or a Msg3 PUSCH transmissions is used for transmission of RRC setup request message in 2-step RACH RA type and 4-step RA type, respectively. Neither Msg3 PUSCH nor MsgA PUSCH can be repeated in NR up to Rel-16.

In both 4-step RACH and 2-step RACH, PRACH resources may be selected based on the SSB selection and a SSB to RACH occasion (RO)/preamble mapping. Detailed procedures of PRACH resource selection may be found in section 5.1.2 and 5.1.2a of 3GPP TS 38.321 for 4-step RACH and 2-step RACH, respectively.

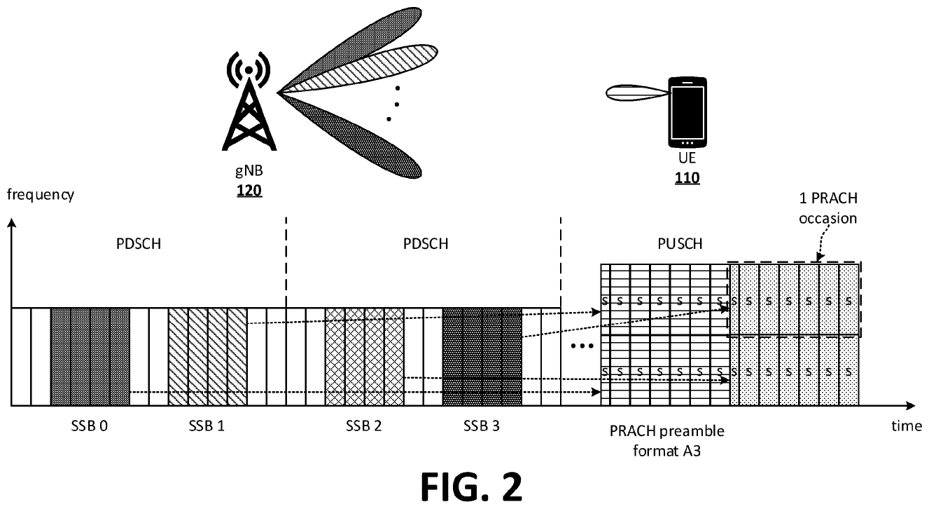

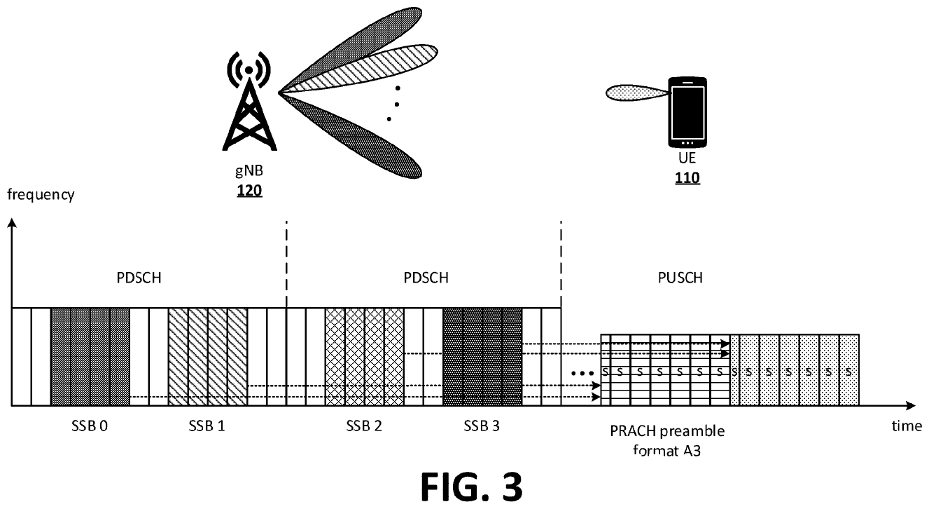

The mapping between SSB and PRACH may be one-to-one, one-to-many, and many-to-one in a predetermined order specified in standard. For example, FIG. 2 and FIG. 3 show exemplary one-to-one and many-to-one mapping between SSB and PRACH occasions, respectively.

When a UE (e.g., the UE 110) determines a good enough SSB beam with Synchronous Signal-Reference Signal Received Power (SS-RSRP) above an RSRP threshold (e.g., rsrp-ThresholdSSB), a preamble in the set of one or more preambles in a PRACH occasion mapped to this SSB may be selected for the random access, then when the gNB (e.g., the gNB 120) detects the preamble, the determined SSB beam for this UE may be known indirectly to some extent so that determined beam can be used for transmitting signals to or receiving signals from this UE.

FIG. 2 shows four SSBs (e.g., SSB 0, SSB1, SSB2, and SSB3) broadcasted by the gNB 120 and four PRACH occasions for the UE 110 to transmit its PRACH for its random access procedure. As shown in FIG. 2, there is one-to-one mapping between the four SSBs and four PRACH occasions, which is indicated by the arrows. After the UE 110 detects the four SSBs and select one of them, for example, the SSB with the highest SS-RSRP (e.g., SSB 1), the UE 110 may choose the PRACH occasion mapped to the SSB 1 for its PRACH transmission. By detecting the PRACH received over the PRACH occasion, the gNB 120 may determine which of the SSBs is selected by the UE 110 (i.e., SSB 1) and corresponding radio resources may be assigned accordingly based on this selection.

FIG. 3 shows four SSBs (e.g., SSB 0, SSB1, SSB2, and SSB3) broadcasted by the gNB 120 and two PRACH occasions for the UE 110 to transmit its PRACH for its random access procedure. As shown in FIG. 3, there is many-to-one mapping between the four SSBs and two PRACH occasions, which is indicated by the arrows. After the UE 110 detects the four SSBs and select one of them, for example, the SSB with the highest SS-RSRP (e.g., SSB 3), the UE 110 may choose the PRACH occasion mapped to the SSB 3 for its PRACH transmission. By detecting the PRACH received over the PRACH occasion, the gNB 120 may determine which ones of the SSBs are selected by the UE 110 (i.e., SSB2 or SSB3) and corresponding radio resources may be assigned accordingly based on this selection.

Please note that the present disclosure is not limited thereto. In some other embodiments, a different number of SSBs and/or a different number of PRACH occasions and/or a different mapping may be provided. Further, although it looks like, in FIG. 2 and FIG. 3, the SSBs and the PRACH occasions are located within a same frequency band, they actually may be not. In some embodiments, they may be located within different frequency bands, for example, different resource elements (REs), different resource blocks (RBs), different bandwidth parts (BWPs), or even different carriers.

ROs for a 2-step RACH may be either separately configured (also known as Type-2 random access procedure with separate configuration of PRACH occasions with Type-1 random access procedure) or are shared with a 4-step RACH (also known as Type-2 random access procedure with common configuration of PRACH occasions with Type-1 random access procedure). In the latter case, different sets of preamble IDs will be used.

For a Type-2 random access procedure with common configuration of PRACH occasions with Type-1 random access procedure, a UE may be provided with a number N of SSBs associated with one PRACH occasion by ssb-perRACH-OccasionAndCB-PreamblesPerSSB and a number Q of contention based preambles per SSB per valid PRACH occasion by MsgA-CB-PreamblesPerSSB. The PRACH transmission can be on a subset of PRACH occasions associated with a same SSB index for a UE provided with a PRACH mask index by MsgA-ssb-sharedRO-MaskIndex. An example of the SSB to RO mapping and the preamble allocation is provided in FIG. 4. Note that only one preamble group is assumed in this example.

As shown in FIG. 4, a total of 64 preambles are configured for a cell. Based on the parameters broadcasted by a gNB (e.g., the gNB 120) and also shown at the upper left corner in FIG. 4, a UE (e.g., the UE 110) may determine how the preambles are grouped and their usages. For example, with the received parameter “#SSBs-per-PRACH-occasion=4”, the UE may determine that the 64 preambles are mapped to 4 SSBs, respectively, and therefore preambles 0-15 are mapped to SSB 0, preambles 16-31 are mapped to SSB 1, preambles 32-47 are mapped to SSB 2, and preambles 48-63 are mapped to SSB 3. Further, with the received parameter “#CB-preambles-per-SSB=4”, the UE may determine that first 4 preambles mapped to each SSB are used for CBRA of Type-1. Furthermore, with the received parameter “#msgA-CB-PreamblesPerSSB=2”, the UE may determine that the next 2 preambles mapped to each SSB are used for CBRA of Type-2. Finally, the UE may determine that the remaining preambles mapped to each SSB are used for CFRA of Type-1.

For a Type-2 random access procedure with separate configuration of PRACH occasions with Type-1 random access procedure, a UE may be provided with a number N of SSBs associated with one PRACH occasion and a number R of contention based preambles per SSB per valid PRACH occasion by msgA-SSB-PerRACH-OccasionAndCB-PreamblesPerSSB when provided; otherwise, by ssb-perRACH-OccasionAndCB-PreamblesPerSSB. Since the SSB to RO mapping and the preamble allocation are independently configured, the example provided for 4-step RACH in FIG. 4 may also be valid for this case of 2-step RACH except that the parameters are separately configured for 2-step RACH.

For both 2-step RACH and 4-step RACH, 2 preamble groups, group A and group B may be configured, such that the network can be made aware of that a greater TB size may be scheduled in a MsgA/Msg3 PUSCH transmission when a preamble in group B is detected by the network.

The preamble group signalling may be done by introducing through the fields:

| | |
|---|---|
| groupBconfigured | SEQUENCE { |
| ra-Msg3SizeGroupA | ENUMERATED {b56, b144, b208, b256, b282, b480, b640, |
| | b800, b1000, b72, spare6, spare5,spare4, |

spare3, spare2, spare1},

| | |
|---|---|
| messagePowerOffsetGroupB | ENUMERATED { minusinfinity, dB0, dB5, dB8, dB10, |

dB12, dB15, dB18},

| | |
|---|---|
| numberOfRA-PreamblesGroupA | INTEGER (1..64) |

}

ra-Msg3SizeGroupA
Transport Blocks size threshold in bits below which the UE shall use a
contention-based RA preamble of group A. (see TS 38.321 [3],
clause 5.1.2).
messagePowerOffsetGroupB
Threshold for preamble selection. Value is in dB. Value minusinfinity
corresponds to -infinity. Value dB0 corresponds to 0 dB, dB5
corresponds to 5 dB and so on. (see TS 38.321 [3], clause 5.1.2)
numberOfRA-PreamblesGroupA
The number of CB preambles per SSB in group A. This determines
implicitly the number of CB preambles per SSB available in group
B. (see TS 38.321 [3], clause 5.1.1). The setting should be
consistent with the setting of ssb-perRACH-OccasionAndCB-
PreamblesPerSSB.

The selection of the preamble group B may be done by evaluating whether the pathloss is lower than a certain threshold by an offset, for example, indicated by the parameter messagePowerOffsetGroupB. This is done to make sure that the UE has good enough coverage to transmit a larger transport block. Furthermore, before checking the pathloss threshold, the UE may first check whether the potential Msg3 size is above a threshold (ra-Msg3SizeGroupA) or not, and then the numberOfRA-PreamblesGroupA determines how many preambles that group A should have, which will also imply how many preambles are allocated for group B.

During the discussions in the meetings from 3GPP RAN1 #104-e, the first meeting of the NR coverage enhancement work item in Rel-17, to 3GPP RAN1 #105-e, following agreements have been made regarding the Msg3 repetition criteria:
UE determines a separate PRACH resource (separate preamble and/or separate PRACH occasions) based at least on RSRP of the downlink pathloss reference and the RSRP threshold;
Based on the PRACH resource on which a PRACH is detected, gNB is aware of whether a Msg3 repetition can be enabled for the UE sending this PRACH.

Based on the agreement, at least preamble partitioning or grouping (i.e., a separate group of preambles on the PRACH occasions shared with legacy PRACH transmission) will be supported for requesting Msg3 repetition.

Agreement: For Msg3 PUSCH repetition, support the following modified Option 2-1.
Option 2-1: For UE requested Msg3 PUSCH repetition with gNB indicating the number of repetitions,
   A UE can request Msg3 PUSCH repetition via separate PRACH resources (For further study (FFS) details, e.g., separate PRACH occasion or separate PRACH preamble in case of shared PRACH occasions after SSB association, etc.).
      Whether a UE would request is based on some conditions, e.g., measured SS-RSRP threshold, which may or may not have spec impact.
   If Msg3 PUSCH repetition is requested by UE, gNB decides whether to schedule Msg3 PUSCH repetition or not. If scheduled, gNB decides the number of repetitions for Msg3 PUSCH 3 (re)-transmission.
   FFS the UE capability of supporting Msg3 PUSCH repetition can be reported after initial access procedure as usual
   FFS details if any.

Agreement: A UE requests Msg3 PUSCH repetition at least when the RSRP of the downlink pathloss reference is lower than an RSRP threshold.
FFS the determination of the RSRP threshold.

Agreement:
For requesting Msg3 PUSCH repetition, support the following:
   Use separate preamble with shared RO configured by the same PRACH configuration index with legacy UEs.
      FFS whether to introduce a PRACH mask to indicate a sub-set of ROs associated with a same SSB index within an SSB-RO mapping cycle for requesting Msg3 repetition for a UE.
      FFS definition of shared RO (e.g., whether the shared RO can be an RO with preamble(s) for 4-step RACH only or with preambles for both 4-step RACH and 2-step RACH).
   FFS whether or not to additionally support one (& only one) more option:
      E.g., option 2: Use separate RO configured by a separate PRACH configuration index from legacy UEs
      E.g., Option 3: Use separate RO, which include
         the separate RO configured by a separate RACH configuration index from legacy UE, and
         the remaining RO (if any) configured, by the same PRACH configuration index with legacy UEs, that cannot be used by legacy rules for PRACH transmission.

According to the RAN1 agreements listed above, to determine whether a UE should request Msg3 repetition or not, a UE may measure the RSRP, then determine whether the RSRP is below a threshold, and then the UE may signal to a gNB that it is above or below a threshold by means of either choosing a separate preamble group or a separate random access time/frequency resources.

Preambles can also be configured to indicate whether a UE has more data that it wants to send in Msg3 through what is known as preamble group B as described above.

However, it is unclear whether it is possible to have different preamble groups corresponding to different Msg3 TB sizes when PRACH resource for requesting Msg3 repetition is selected, thus there should be signaling and procedures that will indicate whether to use greater TB sizes when performing repetitions of Msg3.

When 4-step RACH and/or 2-step RACH are sharing ROs for RA with PRACH preambles for requesting Msg3 repetition, whether PRACH preambles for Msg3 repetition should be allocated after the legacy 4-step RA preambles or after legacy 2-step RA preambles or between them need to be addressed.

Further, when more separate groups of PRACH resources are expected to be used for indicating multiple new features comprising the Msg3 repetition feature, how to allocate the resources in an order needs to be specified. Further, in this case, the PRACH resource overhead may be another problem which should be considered, e.g., some of the features may have to be combined together so that the indication of them could be based on same PRACH resource (preamble, time/frequency resource, or a combination thereof).

Some embodiments of the present disclosure provide methods to enable a preamble group (or multiple preamble groups), e.g., preamble group B, which indicates that the UE has more data in its buffers along with repetitions. Some embodiments of the present disclosure also provide methods on how to allocate the msg3 repetition preambles along with the preamble allocations for legacy 4-step RACH, 2-step RACH and/or other features indicated by PRACH transmissions.

With a set of procedures described in some embodiments, a UE may be allowed to correctly set and signal that it needs greater TB size for Msg3 along with repetitions. Some embodiments may also provide methods on how to allocate the Msg3 repetition preambles along with the preamble allocations for legacy 4-step RACH, 2-step RACH and other features indicated by PRACH transmissions.

Some embodiments of the present disclosure deal with procedures for preamble group B and Msg3 repetitions (or any other feature or a combination of features).

Please note that following terms are used hereinafter:
rsrp-ThresholdSSB is the legacy RSRP threshold to select an SSB in 3GPP TS 38.321.
UE_SSB_RSRP denotes the RSRP measured by a UE on an SSB.
rsrp-Repetitions denotes the agreed RSRP threshold for deciding whether to select the PRACH resource for requesting msg3 repetitions (see the agreement described above).

In some embodiments, PRACH resource may be the PRACH time frequency resources and/or PRACH preamble sequences.

In some embodiments, the “Msg3 repetition PRACH resource selection” may refer to the PRACH resource selection based on the conditions on whether a PRACH resource used for requesting Msg3 repetition should be selected. In some embodiments, “Msg3 repetition PRACH resource” may refer to the PRACH resource separately configured for UE to request Msg3 repetition, i.e., the PRACH resources for requesting Msg3 repetition.

In some embodiments, the “SSB selection” may refer to the SSB selection for further PRACH resource selection as PRACH resources are always associated to SSBs.

In some embodiments, the “preamble group B” may refer to a separate preamble group to indicate a different TB size of msg3 PUSCH. However, the exact name of the preamble group may be different from “group B”.

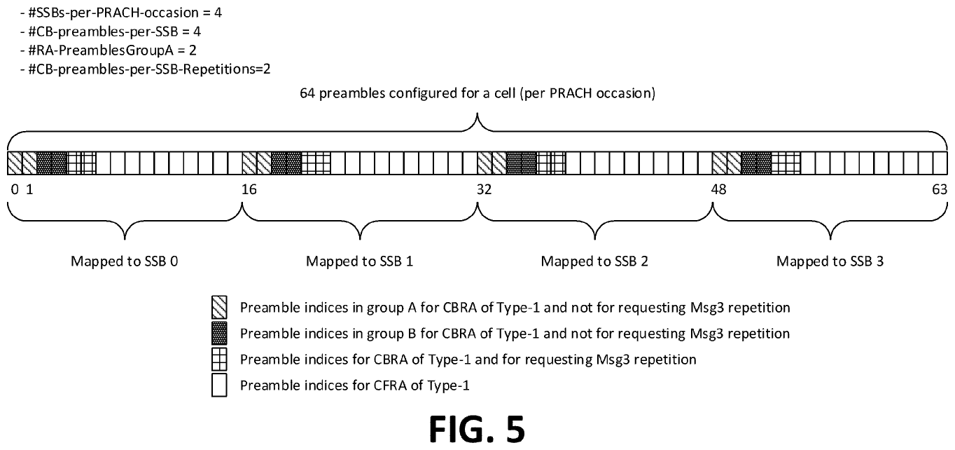

In some embodiments, a preamble group B may only be configured for the PRACH resources not used for requesting Msg3 repetitions. This means that if the UE has decided to request Msg3 repetitions, it may ignore the parameters for group B and build its Msg3 transport block assuming only one group is used. FIG. 5 shows an exemplary preamble grouping according to these embodiments.

Similar to FIG. 4, a total of 64 preambles are configured for a cell in the embodiment shown in FIG. 5. Based on the parameters broadcasted by a gNB (e.g., the gNB 120) and also shown at the upper left corner in FIG. 5, a UE (e.g., the UE 110) may determine how the preambles are grouped and their usages.

To be specific, with the received parameter “#SSBs-per-PRACH-occasion=4”, the UE may determine that the 64 preambles are mapped to 4 SSBs, respectively, and therefore preambles 0-15 are mapped to SSB 0, preambles 16-31 are mapped to SSB 1, preambles 32-47 are mapped to SSB 2, and preambles 48-63 are mapped to SSB 3.

Further, with the received parameter “#CB-preambles-per-SSB=4”, the UE may determine that first 4 preambles mapped to each SSB are used for CBRA of Type-1. Furthermore, with the received parameter “#RA-preamblesGroupA=2”, the UE may determine that the first 2 out of the 4 preambles allocated for CBRA of Type-1 are used for CBRA of Type-1 with a TB size less than or equal to a threshold indicated by “ra-Msg3SizeGroupA”, and that the second 2 out of the 4 preambles are used for CBRA of Type-1 with a TB size greater than the threshold indicated by “ra-Msg3SizeGroupA”. None of them indicates requesting Msg3 repetition.

Furthermore, with the received parameter “#CB-preambles-per-SSB-Repetitions=2”, the UE may determine that the 5th and 6th preambles mapped to each SSB are used for CBRA of Type-1 with Msg3 repetition requested.

Finally, the UE may determine that the remaining preambles mapped to each SSB are used for CFRA of Type-1.

Please note that although no preamble is allocated for CBRA or CFRA of Type-2 in the embodiment shown by FIG. 5, for example, due to a separate RO is assigned for Type-2 RA procedures, the present disclosure is not limited thereto. In some other embodiments, one or more preambles may be allocated for CBRA or CFRA of Type-2, which may located at one of:
between the preambles for not requesting Msg3 repetition and the preambles for requesting Msg3 repetition;
after the preambles for requesting Msg3 repetition; and
any other appropriate locations.

In some embodiments, the preambles used for the msg3 repetition request/indication may be considered as forming its own group, for example, named preamble group C.

In some embodiments, this can be done with the following text proposal:
3GPP TS 38.321:
2> else if Msg3 buffer is empty:
   3> if Random Access resources associated with msg3 repetitions were selected:
      4> select the Random Access Preambles associated with msg3 repetitions.
   3> else:
      4> if Random Access Preambles group B is configured:
         5> if the potential Msg3 size (UL data available for transmission plus MAC subheader(s) and, where required, MAC CEs) is greater than ra-Msg3SizeGroupA and the pathloss is less than PCMAX (of the Serving Cell performing the Random Access Procedure)—preambleReceivedTargetPower—msg3-DeltaPreamble—messagePowerOffsetGroupB, or
         5> if the Random Access procedure was initiated for the CCCH logical channel and the CCCH SDU size plus MAC subheader is greater than ra-Msg3SizeGroupA:
         6> select the Random Access Preambles group B.
         5> else:
         6> select the Random Access Preambles group A.
      4> else:
         5> select the Random Access Preambles group A.

Please note that: although in the above text proposal the step of determining whether Msg3 repetition is requested or not is performed before the step of determining whether a larger TBS is requested or not, the present disclosure is not limited thereto. In fact, these two steps may be performed in a reverse order, or simultaneously in some other embodiments.

In some other embodiments, a preamble group B may be introduced also for PRACH resources requesting/indicating Msg3 repetition. This means that if a UE has decided to perform Msg3 repetitions, it may still check the Msg3 preamble group condition to determine whether to also signal that it has a greater Msg3 TB size.

In some embodiments, the preamble group B configuration may be the same as the one used for PRACH resources for not requesting Msg3 repetition (e.g., messagePowerOffsetGroupB). In order to make the pathloss selection different for the cases where PRACH resources for Msg3 repetitions have been selected and where legacy resources have been selected, an offset may be used in the former case. Otherwise, a group B cannot be selected for the case where the UE has selected PRACH resources for Msg3 repetitions. In some embodiments, the offset may, for instance, depend on the different thresholds configured for PRACH selection and/or SSB selection.

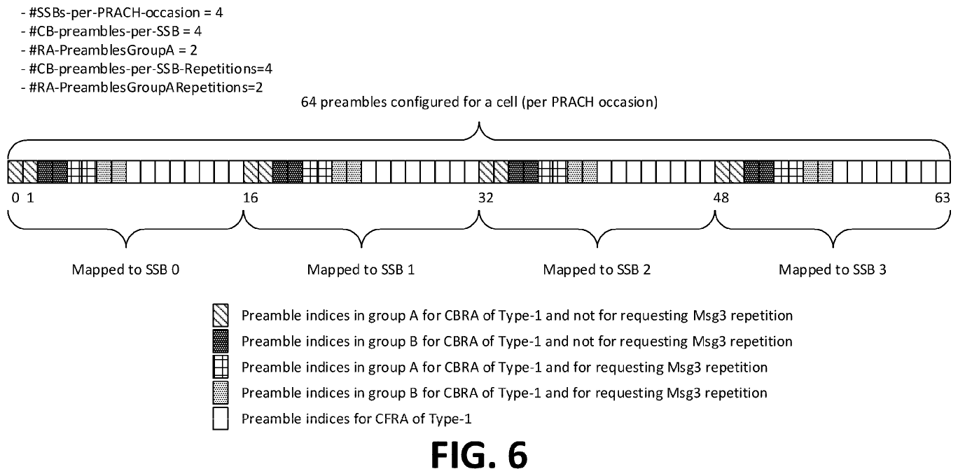

In some embodiments, the configured TB size threshold may be the same as for the non-repetition case. In some embodiments, the number of preambles for group B may be the same as the one used for PRACH resource for not requesting Msg3 repetitions (e.g., numberofRA-PreamblesGroupA). Using preamble grouping configuration for Msg3 repetitions may result in a neat configuration that divides up the grouping in an even way, since in some scenario it could be likely that the need for greater TBS is independent of the coverage, thus the same number of preambles for the groups could fit the scenario. An example is given by FIG. 6.

Similar to FIG. 4 and FIG. 5, a total of 64 preambles are configured for a cell in the embodiment shown in FIG. 6. Based on the parameters broadcasted by a gNB (e.g., the gNB 120) and also shown at the upper left corner in FIG. 6, a UE (e.g., the UE 110) may determine how the preambles are grouped and their usages. To be specific, with the received parameter “#SSBs-per-PRACH-occasion=4”, the UE may determine that the 64 preambles are mapped to 4 SSBs, respectively, and therefore preambles 0-15 are mapped to SSB 0, preambles 16-31 are mapped to SSB 1, preambles 32-47 are mapped to SSB 2, and preambles 48-63 are mapped to SSB 3.

Further, with the received parameter “#CB-preambles-per-SSB=4”, the UE may determine that first 4 preambles mapped to each SSB are used for CBRA of Type-1. Furthermore, with the received parameter “#RA-preamblesGroupA=2”, the UE may determine that the first 2 out of the 4 preambles allocated for CBRA of Type-1 are used for CBRA of Type-1 with a TB size less than or equal to a threshold indicated by “ra-Msg3SizeGroupA”, and that the second 2 out of the 4 preambles are used for CBRA of Type-1 with a TB size greater than the threshold indicated by “ra-Msg3SizeGroupA”. None of them indicates requesting Msg3 repetition.

Further, with the received parameter “#CB-preambles-per-SSB-Repetitions=4”, the UE may determine that the 5^{th} to 8^{th} preambles mapped to each SSB are used for CBRA of Type-1 with Msg3 repetition requested. Furthermore, with the received parameter “#RA-preamblesGroupARepetitions=2”, the UE may determine that the first 2 out of the 4 preambles allocated for CBRA of Type-1 with Msg3 repetition requested are used for CBRA of Type-1 with Msg3 repetition requested and a TB size less than or equal to a threshold indicated by “ra-Msg3SizeGroupA” or a separate threshold indicated by “ra-Msg3SizeGroupARepetitions”, for example, and that the second 2 out of the 4 preambles are used for CBRA of Type-1 with Msg3 repetition requested and a TB size greater than the threshold indicated by “ra-Msg3SizeGroupA” or a separate threshold indicated by “ra-Msg3SizeGroupARepetitions”, for example.

Finally, the UE may determine that the remaining preambles mapped to each SSB are used for CFRA of Type-1.

In some embodiments, group B preamble configuration (e.g., messagePowerOffsetGroupBmsg3Repetition) may be signaled specifically for the PRACH resource for requesting msg3 repetition. In some embodiments, the TBS threshold may be separately signaled for the PRACH resources for requesting msg3 repetition. In some embodiments, the preamble group B configuration for PRACH resources for requesting msg3 repetition may be signaled and configured as an offset to the non-repetition case or even be set by the 3GPP standard or any other standard. These embodiments may allow for more flexibility in how many preambles are allocated to each group for the case when UE has selected the PRACH resources to indicate Msg3 repetitions. If the network knows that UEs that require Msg3 repetitions rarely need greater TB sizes, then the number of preambles for group B may be reduced. Each configuration could for instance be optionally signaled and only used if signaled, and otherwise the same configuration as that for not having selected PRACH resources for msg3 repetitions may be used.

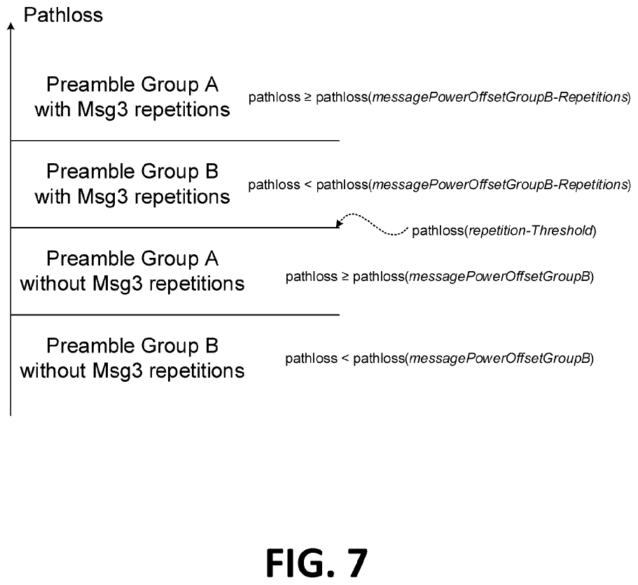

FIG. 7 shows exemplary pathloss ranges for grouping the preambles according to some embodiments. While there is a pathloss threshold (corresponding to the RSRP threshold indicated by repetition-Threshold) for selecting whether to select PRACH resources for Msg3 repetition, the selection between message groups A and B may be based on pathloss thresholds that are determined through the messagePowerOffsetGroupB and messagePowerOffsetGroupB-Repetitions. However, the present disclosure is not limited thereto, and the preambles groups may be divided based on different thresholds, one or more criteria that comprise or do not comprise pathloss, or the like.

Further, although the preambles grouping and selection are performed based on pathloss thresholds in the above embodiment, the present disclosure is not limited thereto. In some other embodiments, the preamble grouping and/or selection may be performed based on RSRP of DL pathloss reference (e.g., a DMRS in an SSB). In such a case, corresponding RSRP thresholds may be used instead of pathloss thresholds, and a similar grouping and/or selection of preambles may be achieved. In yet some other embodiments, a mix of these two kinds of thresholds may be used for preamble grouping and/or selection.

In some embodiments, this may be done with the following text proposal in the case with a separate configuration for preamble group B with repetitions:

### 3GPP TS 38.331:

- RACH-ConfigCommon
The IE RACH-ConfigCommon is used to specify the cell specific random-access parameters.
RACH-ConfigCommon information element

-- ASN1START
-- TAG-RACH-CONFIGCOMMON-START

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S

| | |
|---|---|
| ssb-perRACH-OccasionAndCB-PreamblesPerSSB | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
OPTIONAL, -- Need M

| | |
|---|---|
| groupBconfigured | SEQUENCE { |
| ra-Msg3SizeGroupA | ENUMERATED {b56, b144, b208, b256, b282, b480, b640, |
| | b800, b1000, b72, spare6, spare5,spare4, |

spare3, spare2, spare1},

| | |
|---|---|
| messagePowerOffsetGroupB | ENUMERATED { minusinfinity, dB0, dB5, dB8, dB10, |

dB12, dB15, dB18},

| | |
|---|---|
| numberOfRA-PreamblesGroupA | INTEGER (1..64) |

}
OPTIONAL, -- Need R

| | |
|---|---|
| ra-ContentionResolutionTimer | ENUMERATED { sf8, sf16, sf24, sf32, sf40, sf48, sf56, |

sf64},

| | |
|---|---|
| rsrp-ThresholdSSB | RSRP-Range |

OPTIONAL, -- Need R

| | |
|---|---|
| rsrp-ThresholdSSB-SUL | RSRP-Range |

OPTIONAL, -- Cond SUL

| | |
|---|---|
| prach-RootSequenceIndex | CHOICE { |
| 1839 | INTEGER (0..837), |
| 1139 | INTEGER (0..137) |

},

| | |
|---|---|
| msg1-SubcarrierSpacing | SubcarrierSpacing |

OPTIONAL, -- Cond L139

| | |
|---|---|
| restrictedSetConfig | ENUMERATED {unrestrictedSet, restrictedSetTypeA, |

restrictedSetTypeB},

| | |
|---|---|
| msg3-transformPrecoder | ENUMERATED {enabled} |

```
OPTIONAL, -- Need R
  ...,
  [[
```

| | |
|---|---|
| ra-PrioritizationForAccessIdentity-r16 | SEQUENCE { |
| ra-Prioritization-r16 | RA-Prioritization, |
| ra-PrioritizationForAI-r16 | BIT STRING (SIZE (2)) |

}
OPTIONAL, -- Cond InitialBWP-Only

| | |
|---|---|
| prach-RootSequenceIndex-r16 | CHOICE { |
| l571 | INTEGER (0..569), |
| l1151 | INTEGER (0..1149) |

```
  } OPTIONAL -- Need R
  ]],
```

| | |
|---|---|
| groupBconfiguredRepetitions | SEQUENCE { |
| ra-Msg3SizeGroupArepetitions | ENUMERATED {b56, b144, b208, b256, b282, b480, b640, |
| | b800, b1000, b72, spare6, spare5,spare4, |

spare3, spare2, spare1},

| | |
|---|---|
| messagePowerOffsetGroupBRepetitions | ENUMERATED { minusinfinity, dB0, dB5, dB8, |

dB10, dB12, dB15, dB18},

| | |
|---|---|
| numberOfRA-PreamblesGroupARepetitions | INTEGER (1..64) |

}
}
-- TAG-RACH-CONFIGCOMMON-STOP
-- ASN1STOP

### 3GPP TS 38.321:

| 3> | if Random Access Preambles group B is configured and msg3 repetitions are configured: | |
|---|---|---|
| | 4> | if the potential Msg3 size (UL data available for transmission plus MAC subheader(s) and, where |
| | | required, MAC CEs) is greater than ra-Msg3SizeGroupArepetition and the pathloss is less than |
| | | PCMAX (of the Serving Cell performing the Random Access Procedure) - |
| | | preambleReceivedTargetPower - msg3-DeltaPreamble - messagePowerOffsetGroupBrepetitions; |
| | | or |
| | 4> | if the Random Access procedure was initiated for the CCCH logical channel and the CCCH SDU |
| | | size plus MAC subheader is greater than ra-Msg3SizeGroupArepetition: |

| | |
|---|---|
| 5> | select the Random Access Preambles group B. |

| | |
|---|---|
| 4> | else: |

| | |
|---|---|
| 5> | select the Random Access Preambles group A. |

| 3> | else: | |
|---|---|---|
| | 4> | select the Random Access Preambles group A. |

In some embodiments, when a preamble group is selected based on a first criterion (e.g., whether it is a Type-1 or Type-2 RA procedure, and in this case, Type-2 RA procedure) and a second criterion (e.g., whether a normal TBS or a greater TBS is requested or not, and in this case, a greater TBS is requested) before an RA switching involving a change of the first criterion (e.g., from Type-2 RA procedure to Type-1 RA procedure, for example, due to too many RA failures), a corresponding preamble group selected based on the switched or changed result determined for the first criterion (e.g., Type-1 RA procedure) and the original result determined for the second criterion (e.g., a greater TBS is still requested) may be determined and used for random access after the RA switching.

Further, in some embodiments, the RA switching may occur between an RA for requesting Msg3 repetition and the RA for not requesting Msg3 repetition. For another example, assuming a group A1 (with TBS less than or equal to a threshold) and group B1 (with TBS greater than the threshold) preambles of RA without requesting msg3 repetition are configured, and a group A2 (with TBS less than or equal to another threshold) and group B2 (with TBS greater than the other threshold) preambles of RA with requesting msg3 repetition are also configured. If group A1 is selected for RA without requesting msg3 repetition, and then UE switches to RA with requesting msg3 repetition, the preamble group A2 may be selected for requesting msg3 repetition. In this example, the first criterion is whether Msg3 repetition is requested or not, and the second criterion is whether a normal TBS or a greater TBS is requested.

In some embodiments, the ability of configuring group B may depend on whether the separate ROs or shared RO are configured for signaling msg3 repetitions. For instance, the embodiments where group B is configured only for RA procedures with no Msg3 repetition requested may be used for shared RO case and the embodiments where group B is configured for both RA procedures with and without Msg3 repetition requested may be allowed in the case of separate RO case. This is due to number of preambles may be too few for the shared RO case, since group A and B are already used for the preambles used for signaling that repetitions are not needed in msg3, thus group B is only allowed for separate RO where it is expected that there will be more preambles available.

In some embodiments, more than two preamble groups may be configured for different Msg3 payload size when PRACH resource for requesting msg3 repetition is selected. As an example, 3 preamble groups (A, B, C) may be configured to support small, medium, and large msg3 TB size, respectively. This has some benefits as the repetitions may allow for a large range of transport blocks, and if there are separate RO configured for requesting msg3 repetitions, the number of preambles available may potentially be quite large, which is compared to the case of legacy preamble allocation where the preambles might for instance need to be used for a large number of cases.

In some embodiments, preamble groups can be used to indicate different maximum number of msg3 repetitions requested. With these embodiments, a gNB may schedule a proper number of repetitions for UEs so that the resource utilization efficiency is improved. Here once again, if separate ROs are available, there can be a room for using these types of optimizations. The above embodiment would require a range of thresholds. For example, preamble group A/B/C configured may be used for indicating up to Apr. 8, 2016 msg3 repetitions and these can then be combined with larger transport blocks.

In some embodiments, an entirely new preamble grouping configuration may be introduced so that preamble groups A/B may be combined more flexibly with signaling msg3 repetitions. For instance, a preamble grouping configuration with arbitrary number of preamble groups, where it can be indicated in each preamble group: whether repetitions shall be signaled, whether TB size is greater, whether the preamble group is in a separate PRACH resource or not, any other criterion, or any combination thereof.

An example of this may be seen in the following text proposal:

- RACH-ConfigCommon
The IE RACH-ConfigCommon is used to specify the cell specific random-access parameters.
RACH-ConfigCommon information element

-- ASN1START
-- TAG-RACH-CONFIGCOMMON-START

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S

| | |
|---|---|
| ssb-perRACH-OccasionAndCB-PreamblesPerSSB | CHOICE { |
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
OPTIONAL, -- Need M

| | |
|---|---|
| groupBconfigured | SEQUENCE { |
| ra-Msg3SizeGroupA | ENUMERATED {b56, b144, b208, b256, b282, b480, b640, |

b800, b1000, b72, spare6, spare5,spare4,

spare3, spare2, spare1},

| | |
|---|---|
| messagePowerOffsetGroupB | ENUMERATED { minusinfinity, dB0, dB5, dB8, dB10, |

dB12, dB15, dB18},

| | |
|---|---|
| numberOfRA-PreamblesGroupA | INTEGER (1..64) |

}
OPTIONAL, -- Need R

| | |
|---|---|
| ra-ContentionResolutionTimer | ENUMERATED { sf8, sf16, sf24, sf32, sf40, sf48, sf56, |

sf64},

| | |
|---|---|
| rsrp-ThresholdSSB | RSRP-Range |

OPTIONAL, -- Need R

| | |
|---|---|
| rsrp-ThresholdSSB-SUL | RSRP-Range |

OPTIONAL, -- Cond SUL

| | |
|---|---|
| prach-Root SequenceIndex | CHOICE { |

| | |
|---|---|
| l839 | INTEGER (0..837), |
| l139 | INTEGER (0..137) |

},

| | |
|---|---|
| msg1-SubcarrierSpacing | SubcarrierSpacing |

OPTIONAL, -- Cond L139

| | |
|---|---|
| restrictedSetConfig | ENUMERATED {unrestrictedSet, restrictedSetTypeA, |

restrictedSetTypeB},

| | |
|---|---|
| msg3-transformPrecoder | ENUMERATED {enabled} |

```
OPTIONAL, -- Need R
  ...,
  [[
```

| | |
|---|---|
| ra-PrioritizationForAccessIdentity-r16 | SEQUENCE { |

| | |
|---|---|
| ra-Prioritization-r16 | RA-Prioritization, |
| ra-PrioritizationForAI-r16 | BIT STRING (SIZE (2)) |

}
OPTIONAL, -- Cond InitialBWP-Only

| | |
|---|---|
| prach-RootSequenceIndex-r16 | CHOICE { |

| | |
|---|---|
| l571 | INTEGER (0..569), |
| l1151 | INTEGER (0..1149) |

```
  } OPTIONAL -- Need R
  ]],
  [[
```

| | |
|---|---|
| extendedGroupConfiguration | SEQUENCE (SIZE(1..maxExt-PreambleGroup)) OF |

ExtendedGroupConfiguration
]]
}

| | |
|---|---|
| ExtendedGroupConfiguration ::= | SEQUENCE { |
| msg3Size | ENUMERATED {b56, b144, b208, b256, b282, b480, b640, |

```
  b800, b1000, b72, spare6,
  spare5,spare4, spare3, spare2, spare1},
```

| | |
|---|---|
| messagePowerOffset | ENUMERATED { minusinfinity, minusdB18, minusdB15, |

```
  minusdB12, minusdB10, minusdB8, minusdB5,
  dB0, dB5, dB8, dB10, dB12, dB15, dB18},
```

| numberOfRA-PreamblesGroup | INTEGER (1..64) , | |
|---|---|---|
| separateRO | BOOLEAN, | |
| maxMsg3Rep | ENUMERATED {4, 8, 16} | OPTIONAL, |

| | |
|---|---|
| msg3Rep | BOOLEAN, |
| sdt | BOOLEAN |

}
-- TAG-RACH-CONFIGCOMMON-STOP
-- ASN1STOP

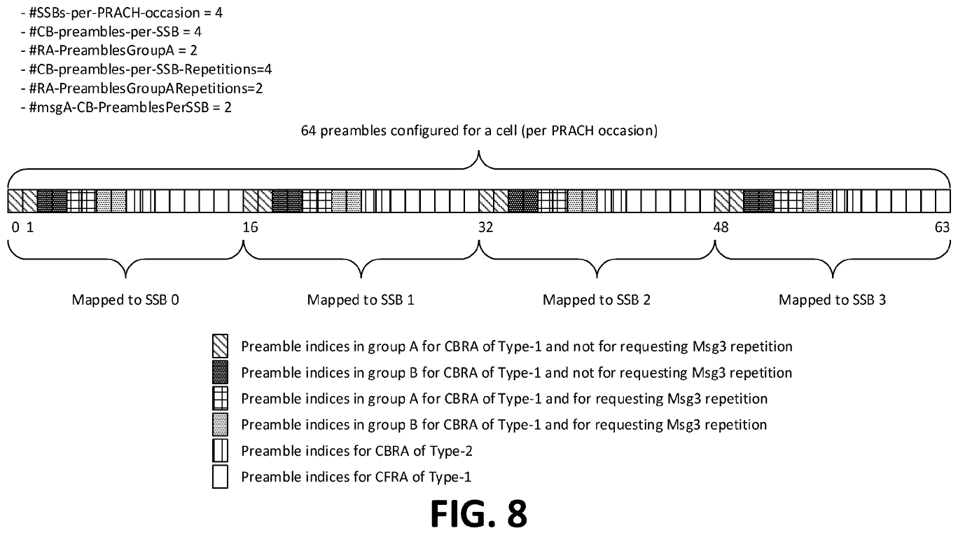

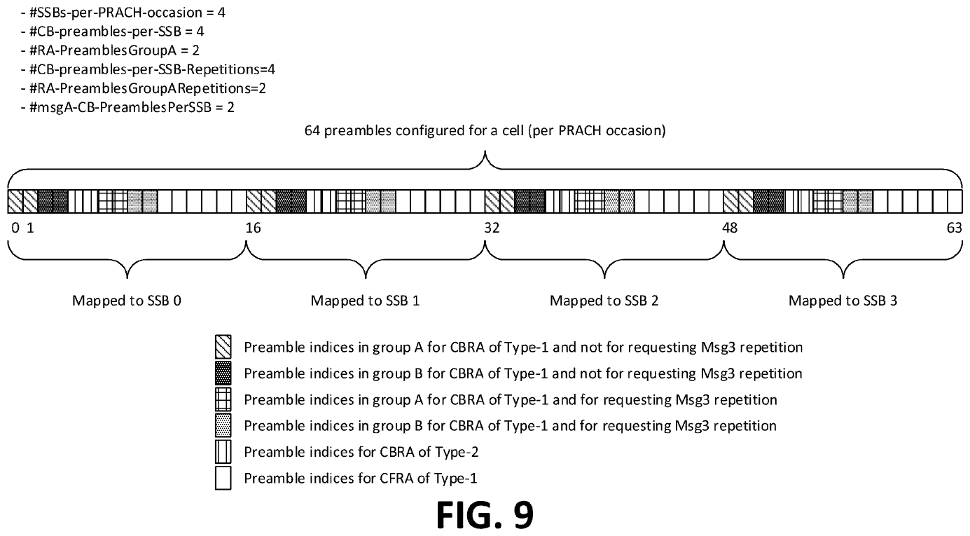

In some embodiments, the CBRA preambles for requesting msg3 repetition may be located in one or more of the following ways:
For each SSB, they may start right after the end of the preamble allocated for legacy 4-step RACH CBRA. For example, as shown in FIG. 6, for a number of preambles per SSB, the CBRA preambles for requesting Msg3 repetition may be allocated right after the 4 preambles (2 in group A, 2 in group B) for legacy 4-step RA not for requesting msg3 repetition.
For each SSB, they may start right after the end of the preamble allocated for 2-step RACH CBRA (if configured). For example, as shown in FIG. 9, for a number of preambles per SSB, the CBRA preambles for requesting msg3 repetition may be allocated right after the 2 CBRA preambles for 2-step RA.
For each SSB, they may start right after the end of the preamble allocated for legacy 4-step RACH CBRA and before the start of 2-step RACH (if configured). For example, as shown in FIG. 8, for a number of preambles per SSB, the CBRA preambles for requesting msg3 repetition may be allocated between the 4 preambles (2 in group A, 2 in group B) in legacy 4-step RA not for requesting msg3 repetition and the 2 CBRA preambles for 2-step RA.

With these embodiments, the preambles for requesting msg3 repetition may be located close to the preambles used for legacy RA so that they may use a same root value with difference cyclic shifts for PRACH sequence generation to reduce the probability that a Msg3 repetition PRACH is mis-detected as a PRACH not for requesting Msg3 repetition.

Please note that although some of the embodiments are described in the context of Msg3 repetition, the present disclosure is not limited thereto. In some other embodiments, the feature “Msg3 repetition” may be replaced by one or more of the following features:
The PRACH resource for indicating a network slice;
The PRACH resource for indicating a small data transmission;
The PRACH resource for indicating a RedCap UE (UE with reduced capability);
The PRACH resource for indicating a random access in non-terrestrial network; and
The PRACH resource for indicating a specific service type or UE priority.

In fact, the term “feature” used herein may refer to any function, operation, step, resource, format, rule, and/or standard or the like that is used, performed, executed, enforced, or otherwise involved by UE, a RAN node, any other node, or a combination thereof, to achieve some effect.

In some embodiments, when multiple features (e.g., those mentioned above) are requested/indicated by different PRACH preambles, the preamble allocations for indication of multiple features may be in the order of increasing number of preamble IDs wherein the order may be either RRC configured or predetermined.

In some embodiments, when multiple features (e.g., those mentioned above) are requested/indicated by different PRACH preambles, a group of preambles may be used for indicating more than one features, which can be RRC configured or predetermined. This can be used to reduce the resource overhead for indicating multiple features especially when the number of features is quite great while the PRACH resources overhead is expensive.

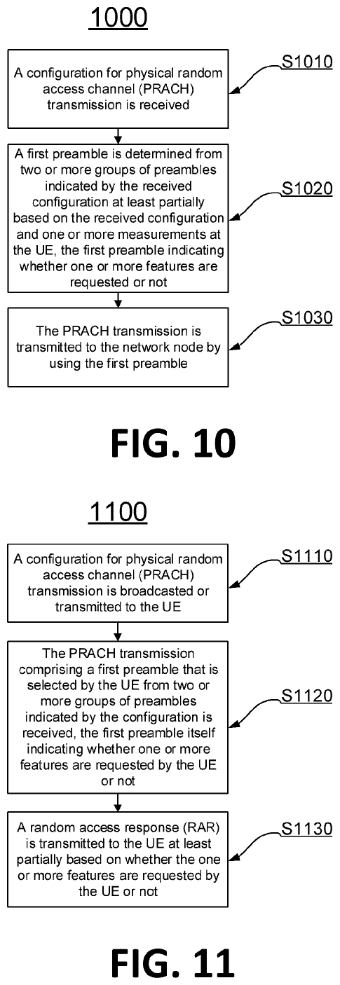

FIG. 10 is a flow chart of an exemplary method 1000 at a UE for feature based preamble grouping according to an embodiment of the present disclosure. The method 1000 may be performed at a user equipment (e.g., the UE 110). The method 1000 may comprise step S1010, S1020, and step S1030. However, the present disclosure is not limited thereto. In some other embodiments, the method 1000 may comprise more steps, less steps, different steps, or any combination thereof. Further the steps of the method 1000 may be performed in a different order than that described herein. Further, in some embodiments, a step in the method 1000 may be split into multiple sub-steps and performed by different entities, and/or multiple steps in the method 1000 may be combined into a single step.

The method 1000 may begin at step S1010 where a configuration for PRACH transmission may be received.

At step S1020, a first preamble may be determined from two or more groups of preambles indicated by the received configuration at least partially based on the received configuration and one or more measurements at the UE, the first preamble indicating whether one or more features are requested or not.

At step S1030, the PRACH transmission may be transmitted to the network node by using the first preamble.

In some embodiments, the first preamble may further indicate that whether a TBS for Msg3 that is greater than a TBS threshold indicated by the received configuration is requested or not. In some embodiments, the one or more features may comprise at least one of: —Msg3 repetition; —MsgA repetition; —a network slice; —SDT; —a RedCap UE; —a random access in non-terrestrial network; and—a specific service type or UE priority.

In some embodiments, the two or more groups may comprise at least a first group and a second group, each preamble in the first group indicating that a first feature of the one or more features is not requested and each preamble in the second group indicating that the first feature is requested. In some embodiments, each preamble in the first group may further indicate that a TBS for Msg3 that is greater than a TBS threshold indicated by the received configuration is not requested, wherein the two or more groups may further comprise a third group, each preamble in the third group indicating: —a TBS for Msg3 that is greater than the TBS threshold is requested; and—the first feature is not requested.

In some embodiments, the two or more groups may comprise no group indicating both of: —a TBS for Msg3 that is greater than the TBS threshold is requested; and—the first feature is requested. In some embodiments, the step S1020 may comprise: determining whether the first feature is to be requested or not; selecting a preamble from the second group as the first preamble in response to determining that the first feature is to be requested. In some embodiments, the step S1020 may comprise: determining whether the first feature is to be requested or not; determining whether a TBS for Msg3 that is greater than the TBS threshold is to be requested or not; selecting a preamble from the first group as the first preamble in response to determining that the first feature is not to be requested and that the greater TBS is not to be requested. In some embodiments, the step S1020 may comprise: determining whether the first feature is to be requested or not; determining whether a TBS for Msg3 that is greater than the TBS threshold is to be requested or not; selecting a preamble from the third group as the first preamble in response to determining that the first feature is not to be requested and that the greater TBS is to be requested.

In some embodiments, the two or more groups may further comprise a fourth group indicating both of: —a TBS for Msg3 that is greater than the TBS threshold is requested; and—the first feature is requested. In some embodiments, the received configuration may comprise a same set of parameters shared by both of the third group and the fourth group. In some embodiments, the same set of parameters may indicate explicitly or implicitly at least one of: —a common TBS threshold below which no preamble shall be selected from the third or fourth group; —a common power threshold below which no preamble shall be selected from the third or fourth group; and—a common number that indicates how many preambles are there in the third or fourth group. In some embodiments, when the same set of parameters comprise no common power threshold, the received configuration may further comprise a parameter indicating a power offset that is used together with the power threshold configured for the third group to determine the power threshold for the fourth group. In some embodiments, the received configuration may comprise separate sets of parameters for the third group and the fourth group, respectively. In some embodiments, each of the separate sets of parameters may indicate explicitly or implicitly at least one of: —a group specific TBS threshold below which no preamble shall be selected from a corresponding group; —a group specific power threshold below which no preamble shall be selected from a corresponding group; —a group specific number that indicates how many preambles are there in a corresponding group.

In some embodiments, the step S1020 may comprise: determining one of multiple pathloss ranges to which a first pathloss, which is determined at least partially based on RSRP of a downlink pathloss reference measured at the UE, belongs; and selecting a preamble from one of the first, second, third, and fourth group as the first preamble at least partially based on the determined pathloss range. In some embodiments, the multiple pathloss ranges may comprise: —a first pathloss range, any value of which being greater than or equal to a first pathloss threshold, wherein no preamble shall be selected from the fourth group when the first pathloss is greater than or equal to the first pathloss threshold; —a second pathloss range, any value of which being less than the first pathloss threshold and greater than a second pathloss threshold corresponding to a power threshold that is configured for determining whether the first feature is to be requested or not; —a third pathloss range, any value of which being less than or equal to the second pathloss threshold and greater than or equal to a third pathloss threshold, wherein no preamble shall be selected from the third group when the first pathloss is greater than or equal to the third pathloss threshold; and—a fourth pathloss range, any value of which being less than the third pathloss threshold.

In some embodiments, the step of selecting a preamble from one of the first, second, third, and fourth group as the first preamble at least partially based on the determined pathloss range may comprise at least one of: selecting a preamble from the second group as the first preamble at least partially in response to determining that the first pathloss belongs to the first pathloss range and determining that a TBS for Msg3 that is greater than the TBS threshold is not to be requested; selecting a preamble from the fourth group as the first preamble at least partially in response to determining that the first pathloss belongs to the second pathloss range and determining that a TBS for Msg3 that is greater than the TBS threshold is to be requested; selecting a preamble from the first group as the first preamble at least partially in response to determining that the first pathloss belongs to the third pathloss range and determining that a TBS for Msg3 that is greater than the TBS threshold is not to be requested; and selecting a preamble from the third group as the first preamble at least partially in response to determining that the first pathloss belongs to the fourth pathloss range and determining that a TBS for Msg3 that is greater than the TBS threshold is to be requested.

In some embodiments, whether the two or more groups comprise a fourth group or not may be at least partially based on whether RO are shared by a first RA procedure to which the PRACH transmission belongs and a second RA procedure that is different from the first RA procedure or not, wherein the fourth group may indicate both of: —a TBS for Msg3 that is greater than the TBS threshold is requested; and—the first feature is requested. In some embodiments, the second RA procedure may be different from the first RA procedure in at least one of: —whether at least one of the one or more features is requested or not; —whether a feature other than the one or more features is requested or not; and—whether it is a Type-1 RA procedure or a Type-2 RA procedure.

In some embodiments, when the received configuration indicates RO are shared by the first and second RA procedures, the two or more groups may comprise no group that indicates both of: —a TBS for Msg3 that is greater than the TBS threshold is requested; and—the first feature is requested. In some embodiments, when the received configuration indicates RO are not shared by the first and second RA procedures, the two or more groups may further comprise a fourth group that indicates both of: —a TBS for Msg3 that is greater than the TBS threshold is requested; and—the first feature is requested.

In some embodiments, the two or more groups may comprises at least a first group and multiple second groups, each preamble in the first group indicating that a first feature of the one or more features is not requested and each preamble in each second group indicating that the first feature is requested, wherein each preamble in each second group may indicate that a TBS for Msg3 that belongs to a TBS range configured for the corresponding second group is requested. In some embodiments, when the first feature is Msg3 repetition, each of the two or more groups indicating that Msg3 repetition is requested may be associated with a group specific maximum number of Msg3 repetitions requested. In some embodiments, the group specific maximum number of Msg3 repetitions requested may be signaled by the network node.

In some embodiments, the received configuration may comprise one or more criteria for dividing all the preambles, which are available for grouping, into the two or more groups, and the one or more criteria may comprise at least one of: —whether a preamble is used for CBRA or CFRA; —whether a preamble is used for Type-1 RA procedure or Type-2 RA procedure; —whether RACH occasions are shared or separately configured for Type-1 and Type-2 RACH procedures; —whether a TBS for Msg3 that belongs to a specific TBS range is requested or not; —a power threshold for determining whether the UE is allowed to use preambles in a corresponding group based on its measured RSRP of the DL pathloss reference; —whether a specific maximum number of Msg3 repetitions is requested or not; —whether Msg3 repetition is requested or not; —whether MsgA repetition is requested or not; —whether a network slice is requested or not; —whether SDT is requested or not; —whether to indicate the UE as a RedCap UE or not; —whether to indicate a random access in non-terrestrial network or not; and—whether to indicate a specific service type or UE priority.

In some embodiments, the method 1000 may further comprise: in response to an RA switching for changing at least one of the one or more criteria, determining a second preamble from the two or more groups at least partially based on the first preamble determined before the RA switching. In some embodiments, a first part of configuration request indicated by the second preamble may be different from a corresponding first part of configuration request indicated by the first preamble, each of the first parts being related to the at least one criterion, and a second part of the request indicated by the second preamble may be same as a corresponding second part of the request indicated by the first preamble, each of the second parts being related to other criteria than the at least one criterion.

In some embodiments, the two or more groups may be sequentially ordered in its preamble space as follows: —a group for CBRA of Type-1 RA indicating a TBS that is less than or equal to a TBS threshold and indicating the first feature is not requested, if present; —a group for CBRA of Type-1 RA indicating a TBS that is greater than a TBS threshold and indicating the first feature is not requested, if present; —a group for CBRA of Type-1 RA indicating a TBS that is less than or equal to a TBS threshold and indicating the first feature is requested, if present; —a group for CBRA of Type-1 RA indicating a TBS that is greater than a TBS threshold and indicating the first feature is requested, if present; —a group for CBRA of Type-2 RA indicating a TBS that is less than or equal to a TBS threshold and indicating the first feature is not requested, if present; —a group for CBRA of Type-2 RA indicating a TBS that is greater than a TBS threshold and indicating the first feature is not requested, if present; and—a group for CFRA of Type-1 RA indicating a TBS that is less than or equal to a TBS threshold, if present.

In some embodiments, the two or more groups may be sequentially ordered in its preamble space as follows: —a group for CBRA of Type-1 RA indicating a TBS that is less than or equal to a TBS threshold and indicating the first feature is not requested, if present; —a group for CBRA of Type-1 RA indicating a TBS that is greater than a TBS threshold and indicating the first feature is not requested, if present; —a group for CBRA of Type-2 RA indicating a TBS that is less than or equal to a TBS threshold and indicating the first feature is not requested, if present; —a group for CBRA of Type-2 RA indicating a TBS that is greater than a TBS threshold and indicating the first feature is not requested, if present; —a group for CBRA of Type-1 RA indicating a TBS that is less than or equal to a TBS threshold and indicating the first feature is requested, if present; —a group for CBRA of Type-1 RA indicating a TBS that is greater than a TBS threshold and indicating the first feature is requested, if present; and—a group for CFRA of Type-1 RA indicating a TBS that is less than or equal to a TBS threshold, if present.

However, the present disclosure is not limited thereto. In some other embodiments, one or more groups with another combination of features may be configured and ordered in the preamble space as well. For example, a group for CFRA of Type 2 RA indicating a TBS that is greater than a TBS threshold and indicating the first feature (e.g., Msg3 repetition) is not requested may be present in the preamble space and located at a specific location that is signaled by the gNB or predetermined.

In some embodiments, one or more groups for indicating that the first feature is requested may be generated from a same root value as that for one or more groups for CBRA of Type-1 RA and/or one or more groups for CBRA of Type-2 RA.

In some embodiments, the two or more groups may be sequentially ordered in its preamble space by their numbers of preambles in a predetermined order or an order signaled from the network node. In some embodiments, the order may be an increasing order. In some embodiments, when the PRACH transmission is not a part of a Type-2 RA procedure, the method 1000 may further comprise: receiving, from the network node, a RAR comprising an indicator indicating whether the first feature is to be used or not; and transmitting, to the network node, a Msg3 with or without the first feature depending on the received indicator.

FIG. 11 is a flow chart of an exemplary method 1100 at a network node for feature based preamble grouping according to an embodiment of the present disclosure. The method 1100 may be performed at a network node (e.g., the gNB 120). The method 1100 may comprise step S1110, S1120, and step S1130. However, the present disclosure is not limited thereto. In some other embodiments, the method 1100 may comprise more steps, less steps, different steps, or any combination thereof. Further the steps of the method 1100 may be performed in a different order than that described herein. Further, in some embodiments, a step in the method 1100 may be split into multiple sub-steps and performed by different entities, and/or multiple steps in the method 1100 may be combined into a single step.

The method 1100 may begin at step S1110 where a configuration for PRACH transmission may be broadcasted or transmitted to the UE.

At step S1120, the PRACH transmission comprising a first preamble that is selected by the UE from two or more groups of preambles indicated by the configuration may be received, the first preamble itself indicating whether one or more features are requested by the UE or not.

At step S1130, a RAR may be transmitted to the UE at least partially based on whether the one or more features are requested by the UE or not.

In some embodiments, the first preamble may further indicate that whether a TBS for Msg3 that is greater than a TBS threshold indicated by the received configuration is requested or not. In some embodiments, the one or more features may comprise at least one of: —Msg3 repetition; —MsgA repetition; —a network slice; —SDT; —a RedCap UE; —a random access in non-terrestrial network; and—a specific service type or UE priority. In some embodiments, the two or more groups may comprise at least a first group and a second group, each preamble in the first group indicating that a first feature of the one or more features is not requested and each preamble in the second group indicating that the first feature is requested. In some embodiments, each preamble in the first group may further indicate that a TBS for Msg3 that is greater than a TBS threshold indicated by the received configuration is not requested, wherein the two or more groups further comprises a third group, each preamble in the third group indicating: —a TBS for Msg3 that is greater than the TBS threshold is requested; and—the first feature is not requested.

In some embodiments, the two or more groups may comprise no group indicating both of: —a TBS for Msg3 that is greater than the TBS threshold is requested; and—the first feature is requested. In some embodiments, the two or more groups may further comprise a fourth group indicating both of: —a TBS for Msg3 that is greater than the TBS threshold is requested; and—the first feature is requested. In some embodiments, the configuration may comprise a same set of parameters shared by both of the third group and the fourth group. In some embodiments, the same set of parameters may indicate explicitly or implicitly at least one of: —a common TBS threshold below which no preamble shall be selected by the UE from the third or fourth group; —a common power threshold below which no preamble shall be selected by the UE from the third or fourth group; and—a common number that indicates how many preambles are there in the third or fourth group. In some embodiments, when the same set of parameters comprise no common power threshold, the received configuration may further comprise a parameter indicating a power offset that is used together with the power threshold configured for the third group to determine the power threshold for the fourth group.

In some embodiments, the received configuration may comprise separate sets of parameters for the third group and the fourth group, respectively. In some embodiments, each of the separate sets of parameters may indicate explicitly or implicitly at least one of: —a group specific TBS threshold below which no preamble shall be selected from a corresponding group; —a group specific power threshold below which no preamble shall be selected from a corresponding group; —a group specific number that indicates how many preambles are there in a corresponding group. In some embodiments, the first preamble may belong to a group of the two or more groups corresponding to one of multiple pathloss ranges to which a first pathloss belongs, wherein the first pathloss may be determined by the UE at least partially based on RSRP of a downlink pathloss reference measured at the UE.

In some embodiments, the multiple pathloss ranges may comprise: —a first pathloss range, any value of which being greater than or equal to a first pathloss threshold, wherein no preamble shall be selected from the fourth group when the first pathloss is greater than or equal to the first pathloss threshold; —a second pathloss range, any value of which being less than the first pathloss threshold and greater than a second pathloss threshold corresponding to a power threshold that is configured for determining whether the first feature is to be requested or not; —a third pathloss range, any value of which being less than or equal to the second pathloss threshold and greater than or equal to a third pathloss threshold, wherein no preamble shall be selected from the third group when the first pathloss is greater than or equal to the third pathloss threshold; and—a fourth pathloss range, any value of which being less than the third pathloss threshold.

In some embodiments, whether the two or more groups comprise a fourth group or not may be at least partially based on whether RO are shared by a first RA procedure to which the PRACH transmission belongs and a second RA procedure that is different from the first RA procedure or not, wherein the fourth group may indicate both of: —a TBS for Msg3 that is greater than the TBS threshold is requested; and—the first feature is requested. In some embodiments, the second RA procedure may be different from the first RA procedure in at least one of: —whether at least one of the one or more features is requested or not; —whether a feature other than the one or more features is requested or not; and—whether it is a Type-1 RA procedure or a Type-2 RA procedure.

In some embodiments, when the configuration indicates RO are shared by the first and second RA procedures, the two or more groups may further comprise no group that indicates both of: —a TBS for Msg3 that is greater than the TBS threshold is requested; and—the first feature is requested.

In some embodiments, when the configuration indicates RO are not shared by the first and second RA procedures, the two or more groups may further comprise a fourth group that indicates both of: —a TBS for Msg3 that is greater than the TBS threshold is requested; and—the first feature is requested. In some embodiments, the two or more groups may comprise at least a first group and multiple second groups, each preamble in the first group indicating that a first feature of the one or more features is not requested and each preamble in each second group indicating that the first feature is requested, wherein each preamble in each second group may indicate that a TBS for Msg3 that belongs to a TBS range configured for the corresponding second group is requested. In some embodiments, when the first feature is Msg3 repetition, each of the two or more groups indicating that Msg3 repetition is requested may be associated with a group specific maximum number of Msg3 repetitions. In some embodiments, the group specific maximum number of Msg3 repetitions may be signaled to the UE.

In some embodiments, the configuration may comprise one or more criteria for dividing all the preambles, which are available for grouping, into the two or more groups, and the one or more criteria may comprise at least one of: —whether a preamble is used for CBRA or CFRA; —whether a preamble is used for Type-1 RA procedure or Type-2 RA procedure; —whether RACH occasions are shared or separately configured for Type-1 and Type-2 RACH procedures; —whether a TBS for Msg3 that belongs to a specific TBS range is requested or not; —a power threshold for determining whether the UE is allowed to use preambles in a corresponding group based on its measured RSRP of the DL pathloss reference; —whether a specific maximum number of Msg3 repetitions is requested or not; —whether Msg3 repetition is requested or not; —whether MsgA repetition is requested or not; —whether a network slice is requested or not; —whether SDT is requested or not; —whether to indicate the UE as a RedCap UE or not; —whether to indicate a random access in non-terrestrial network or not; and—whether to indicate a specific service type or UE priority.

In some embodiments, the two or more groups may be sequentially ordered in its preamble space as follows: —a group for CBRA of Type-1 RA indicating a TBS that is less than or equal to a TBS threshold and indicating the first feature is not requested, if present; —a group for CBRA of Type-1 RA indicating a TBS that is greater than a TBS threshold and indicating the first feature is not requested, if present; —a group for CBRA of Type-1 RA indicating a TBS that is less than or equal to a TBS threshold and indicating the first feature is requested, if present; —a group for CBRA of Type-1 RA indicating a TBS that is greater than a TBS threshold and indicating the first feature is requested, if present; —a group for CBRA of Type-2 RA indicating a TBS that is less than or equal to a TBS threshold and indicating the first feature is not requested, if present; —a group for CBRA of Type-2 RA indicating a TBS that is greater than a TBS threshold and indicating the first feature is not requested, if present; and—a group for CFRA of Type-1 RA indicating a TBS that is less than or equal to a TBS threshold, if present.

In some embodiments, the two or more groups may be sequentially ordered in its preamble space as follows: —a group for CBRA of Type-1 RA indicating a TBS that is less than or equal to a TBS threshold and indicating the first feature is not requested, if present; —a group for CBRA of Type-1 RA indicating a TBS that is greater than a TBS threshold and indicating the first feature is not requested, if present; —a group for CBRA of Type-2 RA indicating a TBS that is less than or equal to a TBS threshold and indicating the first feature is not requested, if present; —a group for CBRA of Type-2 RA indicating a TBS that is greater than a TBS threshold and indicating the first feature is not requested, if present; —a group for CBRA of Type-1 RA indicating a TBS that is less than or equal to a TBS threshold and indicating the first feature is requested, if present; —a group for CBRA of Type-1 RA indicating a TBS that is greater than a TBS threshold and indicating the first feature is requested, if present; and—a group for CFRA of Type-1 RA indicating a TBS that is less than or equal to a TBS threshold, if present.

In some embodiments, one or more groups for indicating that the first feature is requested may be generated from a same root value as that for one or more groups for CBRA of Type-1 RA and/or one or more groups for CBRA of Type-2 RA. In some embodiments, the two or more groups may be sequentially ordered in its preamble space by their numbers of preambles in a predetermined order or an order signaled from the network node. In some embodiments, the order may be an increasing order.

In some embodiments, when the PRACH transmission is not a part of a Type-2 RA procedure, the method 1100 may further comprise: receiving, from the UE, a Msg3 with the feature enabled or disabled depending on the RAR.

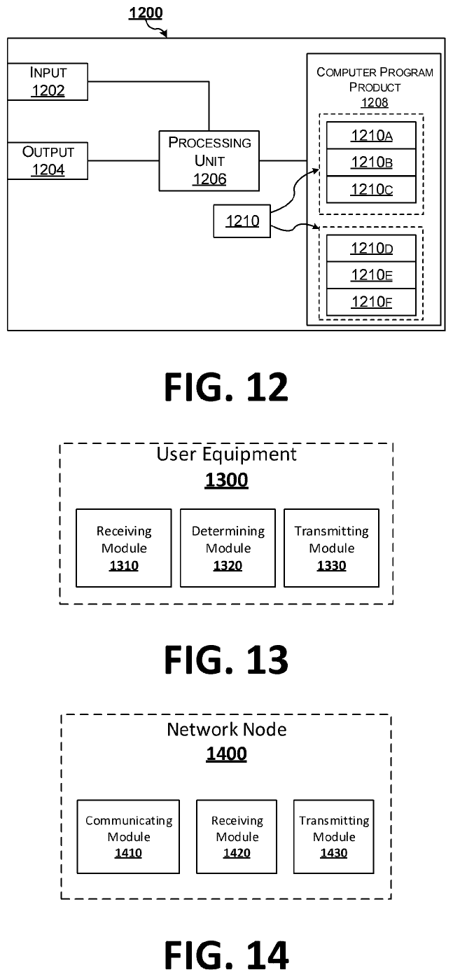

FIG. 12 schematically shows an embodiment of an arrangement 1200 which may be used in a user equipment (e.g., the UE 110) or a network node (e.g., the gNB 120) according to an embodiment of the present disclosure. Comprised in the arrangement 1200 are a processing unit 1206, e.g., with a Digital Signal Processor (DSP) or a Central Processing Unit (CPU). The processing unit 1206 may be a single unit or a plurality of units to perform different actions of procedures described herein. The arrangement 1200 may also comprise an input unit 1202 for receiving signals from other entities, and an output unit 1204 for providing signal(s) to other entities. The input unit 1202 and the output unit 1204 may be arranged as an integrated entity or as separate entities.

Furthermore, the arrangement 1200 may comprise at least one computer program product 1208 in the form of a non-volatile or volatile memory, e.g., an Electrically Erasable Programmable Read-Only Memory (EEPROM), a flash memory and/or a hard drive. The computer program product 1208 comprises a computer program 1210, which comprises code/computer readable instructions, which when executed by the processing unit 1206 in the arrangement 1200 causes the arrangement 1200 and/or the UE/network node in which it is comprised to perform the actions, e.g., of the procedure described earlier in conjunction with FIG. 5 to FIG. 11 or any other variant.

The computer program 1210 may be configured as a computer program code structured in computer program modules 1210A, 1210B, and 1210C. Hence, in an exemplifying embodiment when the arrangement 1200 is used in a UE, the code in the computer program of the arrangement 1200 includes: a module 1210A for receiving a configuration for PRACH transmission; a module 1210B for determining a first preamble from two or more groups of preambles indicated by the received configuration at least partially based on the received configuration and one or more measurements at the UE, the first preamble indicating whether one or more features are requested or not; and a module 1210C for transmitting, to the network node, the PRACH transmission by using the first preamble.

Further, the computer program 1210 may be further configured as a computer program code structured in computer program modules 1210D, 1210E, and 1210F. Hence, in an exemplifying embodiment when the arrangement 1200 is used in a network node, the code in the computer program of the arrangement 1200 includes: a module 1210D for broadcasting or transmitting, to the UE, a configuration for PRACH transmission; a module 1210E for receiving the PRACH transmission comprising a first preamble that is selected by the UE from two or more groups of preambles indicated by the configuration, the first preamble itself indicating whether one or more features are requested by the UE or not; and a module 1210F for transmitting, to the UE, a RAR at least partially based on whether the one or more features are requested by the UE or not.

The computer program modules could essentially perform the actions of the flow illustrated in FIG. 5 to FIG. 11, to emulate the UE or the network node. In other words, when the different computer program modules are executed in the processing unit 1206, they may correspond to different modules in the UE or the network node.

Although the code means in the embodiments disclosed above in conjunction with FIG. 12 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the network node.

Correspondingly to the method 1000 as described above, an exemplary user equipment is provided. FIG. 13 is a block diagram of a UE 1300 according to an embodiment of the present disclosure. The UE 1300 may be, e.g., the UE 110 in some embodiments.

The UE 1300 may be configured to perform the method 1000 as described above in connection with FIG. 10. As shown in FIG. 13, the UE 1300 may comprise a receiving module 1310 for receiving a configuration for PRACH transmission; a determining module 1320 for determining a first preamble from two or more groups of preambles indicated by the received configuration at least partially based on the received configuration and one or more measurements at the UE, the first preamble indicating whether one or more features are requested or not; and a transmitting module 1330 for transmitting, to the network node, the PRACH transmission by using the first preamble.

The above modules 1310, 1320, and/or 1330 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 10. Further, the UE 1300 may comprise one or more further modules, each of which may perform any of the steps of the method 1000 described with reference to FIG. 10.

Correspondingly to the method 1100 as described above, a network node is provided. FIG. 14 is a block diagram of an exemplary network node 1400 according to an embodiment of the present disclosure. The network node 1400 may be, e.g., the gNB 120 in some embodiments.

The network node 1400 may be configured to perform the method 1100 as described above in connection with FIG. 11. As shown in FIG. 14, the network node 1400 may comprise a communicating module 1410 for broadcasting or transmitting, to the UE, a configuration for PRACH transmission; a receiving module 1420 for receiving the PRACH transmission comprising a first preamble that is selected by the UE from two or more groups of preambles indicated by the configuration, the first preamble itself indicating whether one or more features are requested by the UE or not; and a transmitting module 1430 for transmitting, to the UE, a RAR at least partially based on whether the one or more features are requested by the UE or not.

The above modules 1410, 1420, and/or 1430 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 11. Further, the network node 1400 may comprise one or more further modules, each of which may perform any of the steps of the method 1100 described with reference to FIG. 11.

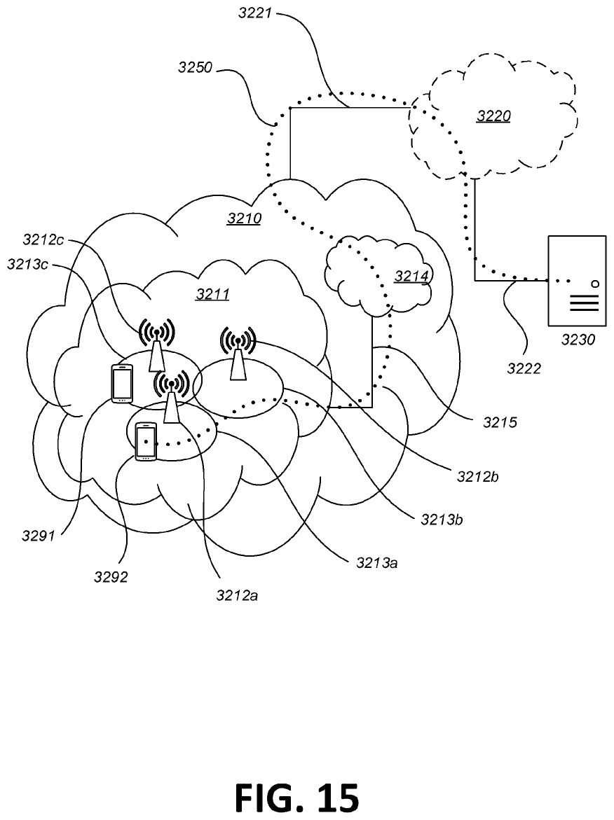

With reference to FIG. 15, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 15 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

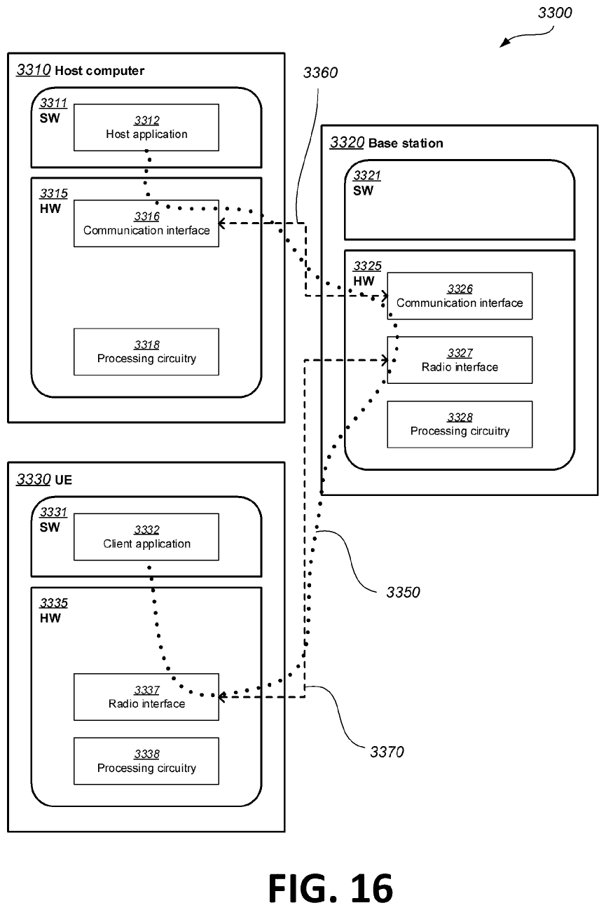

Example implementations, in accordance with an embodiment, of the UE, base station and host computer discussed in the preceding paragraphs will now be described with reference to FIG. 16. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 16) served by the base station 3320. The communication interface 3326 may be configured to facilitate a connection 3360 to the host computer 3310. The connection 3360 may be direct or it may pass through a core network (not shown in FIG. 16) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 16 may be identical to the host computer 3230, one of the base stations 3212a, 3212b, 3212c and one of the UEs 3291, 3292 of FIG. 15, respectively. This is to say, the inner workings of these entities may be as shown in FIG. 16 and independently, the surrounding network topology may be that of FIG. 15.

In FIG. 16, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

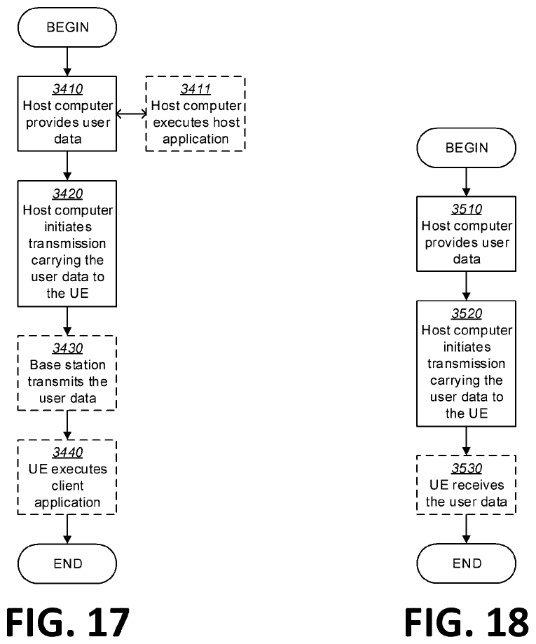

FIG. 17 is a flowchart illustrating a method implemented in a communication system, in accordance with one embodiment. The communication system includes a host computer, a base station and a UE which may be those described with reference to FIG. 15 and FIG. 16. For simplicity of the present disclosure, only drawing references to FIG. 17 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIG. 15 and FIG. 16. For simplicity of the present disclosure, only drawing references to FIG. 18 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

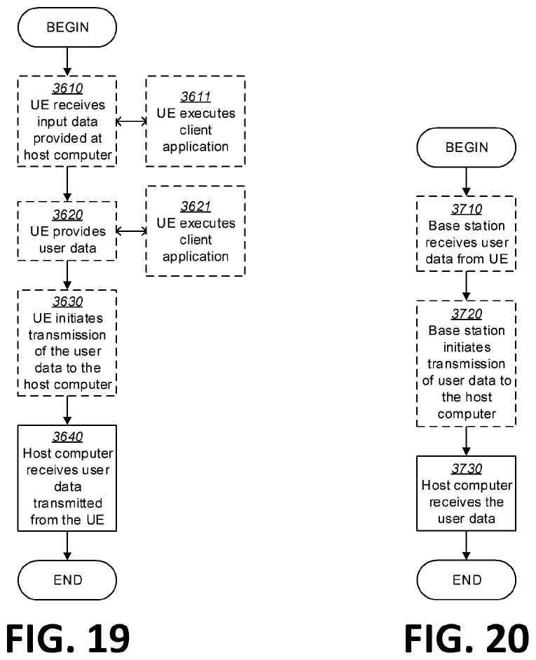

FIG. 19 is a flowchart illustrating a method implemented in a communication system, in accordance with one embodiment. The communication system includes a host computer, a base station and a UE which may be those described with reference to FIG. 15 and FIG. 16. For simplicity of the present disclosure, only drawing references to FIG. 19 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIG. 15 and FIG. 16. For simplicity of the present disclosure, only drawing references to FIG. 20 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| CBRA | Contention Based Random Access |
| CFRA | Contention Free Random Access |
| PRACH | Physical Random Access Channel |
| PUSCH | Physical Uplink Shared Channel |
| RACH | Random Access Channel |
| RO | PRACH occasion, i.e., the timing frequency |
| | resource used for one PRACH transmission |
| RSRP | Reference Signal Received Power |
| SSB | Synchronization Signal Block |
| TB | Transport Block |
| TBS | Transport Block Size |

1. A method at a user equipment (UE) for performing a random access procedure with a network node, the method comprising:
receiving a configuration for physical random access channel (PRACH) transmission;
determining a first preamble from two or more groups of preambles indicated by the received configuration at least partially based on the received configuration and one or more measurements at the UE, the first preamble indicating whether one or more features are requested or not; and
transmitting, to the network node, the PRACH transmission by using the first preamble.

2. The method of claim 1, wherein the first preamble further indicates that whether a transport block size (TBS) for Msg3 that is greater than a TBS threshold indicated by the received configuration is requested or not.

3. The method of claim 1, wherein the one or more features comprise at least one of:
Msg3 repetition;
MsgA repetition;
a network slice;
small data transmission (SDT);
a UE with reduced capability (RedCap UE);
a random access in non-terrestrial network; and
a specific service type or UE priority.

4. The method of claim 1, wherein the two or more groups comprise at least a first group and a second group, each preamble in the first group indicating that a first feature of the one or more features is not requested and each preamble in the second group indicating that the first feature is requested.

5. The method of claim 4, wherein each preamble in the first group further indicates that a TBS for Msg3 that is greater than a TBS threshold indicated by the received configuration is not requested,
wherein the two or more groups further comprises a third group, each preamble in the third group indicating:
a TBS for Msg3 that is greater than the TBS threshold is requested; and
the first feature is not requested.

6. The method of claim 4, wherein the two or more groups comprise no group indicating both of:
a TBS for Msg3 that is greater than the TBS threshold is requested; and
the first feature is requested.

7. The method of claim 6, wherein the step of determining a first preamble comprises:
determining whether the first feature is to be requested or not;
selecting a preamble from the second group as the first preamble in response to determining that the first feature is to be requested.

8. The method of claim 6, wherein the step of determining a first preamble comprises:
determining whether the first feature is to be requested or not;
determining whether a TBS for Msg3 that is greater than the TBS threshold is to be requested or not;
selecting a preamble from the first group as the first preamble in response to determining that the first feature is not to be requested and that the greater TBS is not to be requested.

9. The method of claim 6, wherein the step of determining a first preamble comprises:
determining whether the first feature is to be requested or not;
determining whether a TBS for Msg3 that is greater than the TBS threshold is to be requested or not;
selecting a preamble from the third group as the first preamble in response to determining that the first feature is not to be requested and that the greater TBS is to be requested.

10. The method of claim 4, wherein the two or more groups further comprise a fourth group indicating both of:
a TBS for Msg3 that is greater than the TBS threshold is requested; and
the first feature is requested.

11. The method of claim 10, wherein the received configuration comprises a same set of parameters shared by both of the third group and the fourth group;
the same set of parameters indicate explicitly or implicitly at least one of:
a common TBS threshold below which no preamble shall be selected from the third or fourth group;
a common power threshold below which no preamble shall be selected from the third or fourth group; and
a common number that indicates how many preambles are there in the third or fourth group.

12-13. (canceled)

14. The method of claim 10, wherein the received configuration comprises separate sets of parameters for the third group and the fourth group, respectively; wherein each of the separate sets of parameters indicates explicitly or implicitly at least one of:
a group specific TBS threshold below which no preamble shall be selected from a corresponding group;
a group specific power threshold below which no preamble shall be selected from a corresponding group;
a group specific number that indicates how many preambles are there in a corresponding group.

15-18. (canceled)

19. The method of claim 4, wherein whether the two or more groups comprise a fourth group or not is at least partially based on whether RACH occasions (RO) are shared by a first RA procedure to which the PRACH transmission belongs and a second RA procedure that is different from the first RA procedure or not,
wherein the fourth group indicates both of:
a TBS for Msg3 that is greater than the TBS threshold is requested; and
the first feature is requested;
wherein the second RA procedure is different from the first RA procedure in at least one of:
whether at least one of the one or more features is requested or not;
whether a feature other than the one or more features is requested or not; and
whether it is a Type-1 RA procedure or a Type-2 RA procedure.

20. (canceled)

21. The method of claim 19, wherein when the received configuration indicates RO are shared by the first and second RA procedures, the two or more groups comprise no group that indicates both of:
a TBS for Msg3 that is greater than the TBS threshold is requested; and
the first feature is requested; or
wherein when the received configuration indicates RO are not shared by the first and second RA procedures, the two or more groups further comprise a fourth group that indicates both of:
a TBS for Msg3 that is greater than the TBS threshold is requested; and
the first feature is requested.

22. (canceled)

23. The method of claim 1, wherein the two or more groups comprise at least a first group and multiple second groups, each preamble in the first group indicating that a first feature of the one or more features is not requested and each preamble in each second group indicating that the first feature is requested,
wherein each preamble in each second group indicates that a TBS for Msg3 that belongs to a TBS range configured for the corresponding second group is requested.

24. The method of claim 1, wherein when the first feature is Msg3 repetition, each of the two or more groups indicating that Msg3 repetition is requested is associated with a group specific maximum number of Msg3 repetitions requested; wherein the group specific maximum number of Msg3 repetitions requested is signaled by the network node.

25. (canceled)

26. The method of claim 1, wherein the received configuration comprises one or more criteria for dividing all the preambles, which are available for grouping, into the two or more groups, and the one or more criteria comprise at least one of:
whether a preamble is used for contention based random access (CBRA) or contention free random access (CFRA);
whether a preamble is used for Type-1 RA procedure or Type-2 RA procedure;
whether RACH occasions are shared or separately configured for Type-1 and Type-2 RACH procedures;
whether a TBS for Msg3 that belongs to a specific TBS range is requested or not;
a power threshold for determining whether the UE is allowed to use preambles in a corresponding group based on its measured RSRP of the DL pathloss reference;
whether a specific maximum number of Msg3 repetitions is requested or not;
whether Msg3 repetition is requested or not;
whether MsgA repetition is requested or not;
whether a network slice is requested or not;
whether SDT is requested or not;
whether to indicate the UE as a RedCap UE or not;
whether to indicate a random access in non-terrestrial network or not; and
whether to indicate a specific service type or UE priority.

27-31. (canceled)

32. The method of claim 1, wherein the two or more groups are sequentially ordered in its preamble space by their numbers of preambles in a predetermined order or an order signaled from the network node, wherein the order is an increasing order.

33. (canceled)

34. The method of claim 1, wherein when the PRACH transmission is not a part of a Type-2 RA procedure, the method further comprises:
receiving, from the network node, a random access response (RAR) comprising an indicator indicating whether the first feature is to be used or not; and
transmitting, to the network node, a Msg3 with or without the first feature depending on the received indicator.

35. A user equipment (UE), comprising:
a processor;
a memory storing instructions which, when executed by the processor, cause the processor to perform of: receiving (S1010) a configuration for physical random access channel (PRACH) transmission;
determining (S1020) a first preamble from two or more groups of preambles indicated by the received configuration at least partially based on the received configuration and one or more measurements at the UE, the first preamble indicating whether one or more features are requested or not; and
transmitting (S1030), to the network node, the PRACH transmission by using the first preamble.

36-67. (canceled)
